(19) United States
(12) Patent Application Publication
(10) Pub. No.: US 2024/0308605 A1
(43) Pub. Date: Sep. 19, 2024

(54) A CATERPILLAR APPARATUS FOR MOVING ALONG A SURFACE

(71) Applicant: Assaf COHEN, Herzliya (IL)

(72) Inventor: Assaf COHEN, Herzliya (IL)

(21) Appl. No.: 18/266,651

(22) PCT Filed: Dec. 16, 2021
(86) PCT No.: PCT/IL2021/051500

§ 371 Date: Jun. 12, 2023

Related U.S. Application Data
(60) Provisional application No. 63/126,553, filed on Dec. 17, 2020.

(30) Foreign Application Priority Data
Mar. 25, 2021 (IL) 281841
Sep. 30, 2021 (IL) 286844

(51) Int. Cl. B62D 55/265; B62D 57/024

(52) U.S. Cl. CPC B62D 55/265; B62D 57/024

(57) ABSTRACT

A caterpillar assembly for moving along a non-horizontal surface comprising a track, a moving system, and a plurality of vacuum grippers successively arranged along the track configured be attached to the non-horizontal surface by means of vacuum and move with respect to the track by means of the moving system to advance the caterpillar assembly along the non-horizontal surface.

### TECHNOLOGICAL FIELD

The presently disclosed subject matter relates, in general, to a caterpillar apparatus for moving along a surface, and more particularly to a caterpillar apparatus having vacuum grippers for moving along an inclined/vertical and/or slippery surface.

### BACKGROUND

A caterpillar apparatus of the above kind can be used for a plurality of applications, of which most popular and challenging is cleaning the exteriors, e.g., walls and window panels, of high-rise buildings.

Most of the conventional methods used for cleaning the exteriors of a high-rise building include window washers rappelling down the building and manually cleaning the exteriors thereof.

These methods put in risk the lives of window washers, and more so where there is probability of strong unexpected gusts of wind. Such conventional methods, especially due to the risks involved and the related cautions required, are time consuming, and thereby costly.

Some other devices and methods used for this purpose include window cleaning platforms, also known as suspended gondolas or scaffolds, enabling the window washers to walk therealong and to be secured thereto, or semi/fully automatic systems such as robots and drones.

WO 2019/165859 discloses a cleaning robot comprising a pair of caterpillar tracks arranged opposite to one another, having a plurality of caterpillar track suction cups arranged on the outer surface of the caterpillar tracks, and a negative pressure assembly in communication with the caterpillar track suction cups. The output connector and the caterpillar track suction pads of the cleaning robot rotate synchronously, avoiding the situation of the connecting tubes connecting the caterpillar track suction cups and the negative pressure assembly becoming intertwined.

CN 102631173 discloses a miniature robot capable of walking along and cleaning vertical surfaces such as a glass wall and a ceramic outer wall. The robot walks through a track provided with a sucker connected with a vacuum pump.

U.S. Pat. No. 9,688,326 discloses a drive unit for driving a robot along an inclined surface. An endless tread engages a pair of wheels to define a planar bottom surface of the endless tread, and a vacuum motor pulls air through holes in the endless tread when the holes are aligned with a vacuum opening.

CN205094341 discloses a wall cleaning robot using vacuum adsorption tracks.

Acknowledgement of the above references herein is not to be inferred as meaning that these are in any way relevant to the patentability of the presently disclosed subject matter.

### GENERAL DESCRIPTION

According to an aspect of the presently disclosed subject matter, there is provided a caterpillar assembly for moving along a surface, the assembly having a longitudinal reference plane comprising a longitudinal axis and a central reference plane perpendicular to the longitudinal reference plane and comprising the longitudinal axis and a central axis perpendicular to the longitudinal axis, the assembly having at least one surface gripping face, at least a portion of which is parallel to the central reference plane and which is configured, when in operation, to face said surface, the assembly comprising:
   a moving system; and
   a plurality of vacuum grippers each having a gripping face, the vacuum grippers being arranged so that at each moment, gripping faces of at least two vacuum grippers define said surface gripping face of the assembly and are configured for being attached to said surface when vacuum is applied to these grippers, each gripper being mounted to the moving system so as to be moved from one side to the other side of the central reference plane along the longitudinal reference plane;
   each vacuum gripper is provided with an individual vacuum pump configured for selectively creating vacuum within the gripper.

Optionally, each of the vacuum grippers of the caterpillar assembly can be configured for maintaining the vacuum after termination of operation of the vacuum pump, during the time when the gripping face of the vacuum gripper is attached to the surface, whereby the gripper can be configured to have the following operational modes: a suction mode when the vacuum is created by the vacuum pump and a vacuum mode when the vacuum is maintained after the termination of operation of the vacuum pump.

Optionally, each vacuum gripper can comprise a pump manipulator configured to initiate the operation of the vacuum pump once the vacuum gripper reaches a predetermined starting position.

Optionally, each vacuum gripper can comprise a vacuum releaser configured to release the vacuum maintained in the vacuum gripper once the vacuum gripper reaches a predetermined finishing position.

Optionally, the caterpillar assembly can further comprise at least one starting position indicator configured for signaling to the pump manipulator of each gripper when the gripper reaches the predetermined starting position.

Optionally, the caterpillar assembly can further comprise at least one finishing position indicator configured for signaling to the vacuum releaser of each gripper when the gripper reaches the predetermined finishing position.

The moving system can comprise one or more moving mechanisms operable to move the vacuum grippers or to move a component/components of the moving system to which the vacuum grippers are fixedly connected, so as to bring each gripper from one side to the other side of the central reference plane along the longitudinal reference plane.

For example, the moving system can comprise a movable track drivable by at least one driving mechanism, and each gripper can be fixedly connected to the movable track at locations spaced apart therealong. For example, the moving mechanism can comprise at least one gear configured for movingly engaging the movable track and a driving mechanism, e.g. motor, configured for moving the at least one gear, so as to move the vacuum grippers.

The movable track can be in the form of a continuous conveyor flexible strap or in the form of a succession of discrete elements connected or not connected to each other, each of which at least one vacuum grippers can be mounted to the discrete elements. The discrete elements can be connected therebetween by a plurality of pivot axles.

Optionally, the moving system can comprise a stationary track and wherein each gripper is configured for slidingly engaging the stationary track. Optionally, the stationary track and each gripper can further comprise gears configured for movingly engaging each other securely moving each vacuum gripper along the stationary track.

Optionally, each gripper can further comprise a driving mechanism, e.g. motor configured for moving the gears of gripper along the stationary track.

Optionally, the caterpillar assembly can constitute a part of a caterpillar apparatus comprising at least two caterpillar assemblies and a plane of symmetry, optionally parallel to the longitudinal planes of the two assemblies, such that at least one caterpillar assembly is positioned on each one of the two sides of the plane of symmetry. Optionally, the caterpillar apparatus can comprise at least two caterpillar assemblies as defined hereinabove.

Optionally, the caterpillar assemblies can comprise an equal number of the vacuum grippers which can be arranged such that at each moment the gripping faces of the same number of grippers of the two assemblies define the surface gripping faces of the two assemblies, and constitute a surface gripping face of the apparatus.

Optionally, the apparatus can comprise a base to which the moving system is securely mounted, at least a part of the moving system being rigid to form a structural support for the vacuum grippers.

Optionally, each vacuum gripper can be provided with a mounting portion by which the gripper can be mounted to the moving system and an adjusting device which can be configured for enabling adjustment of the distance between the vacuum gripper, its gripping face or gripping portion and the moving system.

Optionally, the adjusting device can be configured for orienting the vacuum gripper at an adjustable angle with respect to the central reference plane.

Optionally, the individual vacuum pump is two or more individual vacuum pumps configured for selectively creating vacuum within the gripper.

Optionally, the caterpillar apparatus can further comprise a controller configured to control the movement of each one of the vacuum grippers. Optionally, the controller can be configured to control the movement of the moving system.

Optionally, each vacuum gripper can further comprise at least one sensor configured to provide indication of at least the operational mode of the vacuum gripper and, optionally, its malfunction.

Optionally, the caterpillar apparatus can further comprise a pivoting assembly comprising at least one vacuum gripper, and configured to secure the caterpillar apparatus to the surface and pivot the caterpillar apparatus along a central plane of the apparatus perpendicular to the plane of symmetry, at least when the moving systems are inoperative.

Optionally, the controller can further be configured to control the securement and releasement of the caterpillar apparatus to and from said surface via the at least one vacuum gripper of the pivoting assembly. Optionally, the controller can further be configured to control the pivoting of the caterpillar apparatus via said pivoting assembly.

According to another aspect of the presently disclosed subject matter, there is provided a caterpillar assembly for moving along a surface, the caterpillar assembly having a longitudinal reference plane comprising a longitudinal axis and a central reference plane perpendicular to the longitudinal reference plane and comprising the longitudinal axis and a central axis perpendicular to the longitudinal axis, the assembly having at least one surface gripping face, at least a portion of which is parallel to the central reference plane and which is configured, when in operation, to face said surface, the caterpillar assembly comprising:
an endless stationary track and an endless movable track extending adjacent to the stationary track; and
a plurality of vacuum grippers each having a gripping face, the vacuum grippers being arranged so that at each moment, gripping faces of at least two vacuum grippers define said surface gripping face of the assembly and are configured for being attached to said surface when vacuum is applied to these grippers, each gripper being permanently connected to the movable track at locations spaced apart therealong and slidably engaging the stationary track so as to slide therealong when moved by the movable track from one side to the other side of the central reference plane along the longitudinal reference plane.

Optionally, the caterpillar assembly can further comprise a vacuum system configured for selectively applying vacuum to the vacuum grippers so that, at each time, vacuum can be simultaneously maintained within each of the at least two vacuum grippers whose gripping faces define the surface gripping face. Optionally, each vacuum gripper can be provided with an individual vacuum pump configured for selectively creating vacuum within the gripper.

Optionally, each of the vacuum grippers of the caterpillar assembly can be configured for maintaining the vacuum after termination of operation of the vacuum pump, during the time when the gripping face of the vacuum gripper needs to be attached to the surface, whereby the gripper is configured to have at least the following operational modes: a suction mode when the vacuum is created by the vacuum pump, and a vacuum mode when the vacuum is maintained after the termination of operation of the vacuum pump.

Optionally, each vacuum gripper can comprise a pump manipulator configured to initiate the operation of the pump once the vacuum gripper reaches a predetermined starting position.

Optionally, each vacuum gripper can comprise a vacuum releaser configured to release the vacuum maintained in the gripper once the vacuum gripper reaches a predetermined finishing position.

Optionally, the caterpillar assembly can further comprise at least one starting position indicator configured for signaling to the pump manipulator of each gripper when the gripper reaches the predetermined starting position.

Optionally, the caterpillar assembly can further comprise at least one finishing position indicator configured for signaling to the vacuum releaser of each gripper when the gripper reaches the predetermined finishing position.

Optionally, the caterpillar assembly can constitute a part of a caterpillar apparatus comprising at least two caterpillar assemblies, the apparatus comprising a plane of symmetry, optionally parallel to the longitudinal planes of the two assemblies, such that at least one caterpillar assembly is positioned on each one of the two sides of the plane of symmetry. Optionally, the caterpillar apparatus can comprise at least two caterpillar assemblies as defined hereinabove.

Optionally, the caterpillar assemblies can comprise an equal number of the vacuum grippers which can be arranged such that at each moment the gripping faces of the same number of grippers of the two assemblies define the surface gripping faces of the two assemblies, and constitute a surface gripping face of the apparatus.

Optionally, the caterpillar assembly can further comprise a base to which the stationary track is securely mounted, the track being rigid to form a structural support for the vacuum grippers.

Optionally, each vacuum gripper can be provided with a mounting portion by which the gripper is mounted to the stationary track and an adjusting device which is configured for enabling adjustment of the distance between the vacuum gripper, its gripping face or gripping portion and the stationary track.

Optionally, the adjusting device can be configured for orienting the vacuum gripper at an adjustable angle with respect to the central reference plane.

Optionally the individual vacuum pump is two or more individual vacuum pumps configured for selectively creating vacuum within the gripper.

Optionally, each vacuum gripper can further comprise at least one sensor configured to provide indication of at least the operational mode of the vacuum gripper and, optionally, its malfunction.

Optionally, a caterpillar apparatus can comprise at least two caterpillar assemblies, each as defined hereinabove.

Optionally, the caterpillar apparatus can further comprise a controller configured at least to control the movement of the movable tracks of the caterpillar assemblies.

Optionally, the caterpillar apparatus can further comprise a pivoting assembly comprising at least one vacuum gripper, and configured to secure the caterpillar apparatus to the surface and pivot the caterpillar apparatus along a central plane of the apparatus perpendicular to the plane of symmetry, at least when the movable tracks are inoperative.

Optionally, the controller can further be configured to control the securement and releasement of the caterpillar apparatus to and from the surface via the at least one vacuum gripper of the pivoting assembly. Optionally, the controller can further be configured to control the pivoting of the caterpillar apparatus via the pivoting assembly.

The moving system of any caterpillar assembly according to the presently disclosed subject matter can comprise one or more moving mechanisms operable to move the vacuum grippers at least indirectly, so as to bring each gripper from one side to the other side of the central reference plane along the longitudinal reference plane.

For example, the moving system can comprise a movable track drivable by at least one driving mechanism, and each gripper can be fixedly connected to the movable track. For example, the driving mechanism can comprise at least one gear configured for movingly engaging the movable track and a driving mechanism, e.g. motor, configured for moving the at least one gear, so as to move the vacuum grippers.

The movable track can be in the form of a continuous conveyor flexible strap or in the form of a succession of discrete track elements pivotably mounted relative to adjacent track elements, to each of which at least one vacuum grippers can be mounted to the discrete elements. The discrete elements can be connected therebetween by a plurality of pivot axles.

Optionally, the moving system can comprise a stationary track and the at least one attachment element is configured for slidingly engaging the stationary track.

According to another aspect of the presently disclosed subject matter, there is provided a vacuum gripper unit for use in a movable assembly having a moving system, for gripping attachment of the assembly to a surface, the vacuum gripper comprising:
a gripping portion with a gripping face configured to be attached to the surface when vacuum is applied thereto, and a mounting portion opposite to the gripping portion;
the mounting portion configured for being mounted to the moving system via at least one attachment element; and
an adjusting device connected at one end thereof to the gripping portion of the vacuum gripper and at another end thereof to the mounting portion and configured for adjusting a distance between the gripping portion and the mounting portion.

According to another aspect of the presently disclosed subject matter, there is provided a vacuum gripper unit for use in a movable assembly having a moving system, for gripping attachment of the assembly to a surface, the vacuum gripper comprising:
a gripping portion with a gripping face configured to be attached to the surface when vacuum is applied thereto, and a mounting portion opposite to the gripping portion;
the mounting portion configured for being mounted to the moving system via at least one attachment element;
said vacuum gripper is provided with at least one individual vacuum pump configured for selectively creating vacuum within the gripper.

According to still further aspect of the presently disclosed subject matter, there is provided a vacuum gripper unit for use in a caterpillar assembly, the assembly comprising a plurality of vacuum grippers for gripping attachment of the assembly to a surface and a moving system for moving the grippers to successively bring them into contact with said surface, the moving system comprising an endless movable track constituted a plurality of discrete track elements, each associated with a vacuum gripper, and a plurality of pivot axles via which the track elements are pivotally connected to each other, the vacuum gripper having a central axis and comprising:
a gripping portion with a gripping face oriented perpendicular to the central axis of the gripper and attachable to said surface when vacuum is applied to the gripping face;
a mounting portion spaced from the gripping face along the central axis of the gripper and comprising an attachment extension oriented transversely to the central axis and having two attachment ends on two sides of the central axis, the attachment ends being each pivotally connectable to a pivot axle, enabling the attachment extension to constitute the discrete track element of the movable track when the caterpillar assembly is assembled.

Optionally, the attachment extension can have two attachment extension portions extending in opposite directions from the central axis of the gripper, each having a proximal end adjacent the central axis and a distal end spaced from the central axis and pivotally connectable to a pivot axle.

Optionally, the vacuum gripper of any of the above aspects can further comprise an individual vacuum pump configured for selectively creating vacuum within the gripper.

Optionally, the adjusting device can be configured for enabling an orientation of the gripping portion at an adjustable angle with respect to the moving system.

Optionally, the vacuum gripper unit of any of the above aspects can further comprise at least one sensor configured to sense if the gripping portion touches a surface.

Optionally, the vacuum gripper unit of any of the above aspects can further comprise a controller configured to adjust the distance of the adjusting device based on indication received from the at least one sensor.

Optionally, the adjusting device can be a spring, a piston, a telescopic rod, a hydraulic mechanism, other distance adjustable element or any combination thereof.

Optionally, the at least one mounting portion can further comprise gears configured for movingly engaging corresponding gears of the stationary track so as to enable the movement of the vacuum gripper unit.

Optionally, the vacuum gripper unit can further comprise a driving mechanism, e.g. a motor configured for moving the gears of the vacuum gripper along the stationary track.

Optionally, the at least one attachment element can further comprise a detachably attachable mechanism configured for enabling attachment or detachment of the vacuum gripper unit to or from the moving system.

According to still further aspect of the presently disclosed subject matter, there is provided a movable assembly for attaching to a non-horizontal advancement surface and moving therealong; said assembly comprising:
a track having an upward facing sliding surface, a downward facing sliding surface, and at least one sideward facing sliding surface;
a plurality of gripper units by virtue of which said movable assembly is configured to be attached to said advancement surface, each comprising:
   a gripping portion having a gripping face configured to be selectively fixable to said advancement surface, and defining a gripping plane when fixed thereto; said movable assembly having a longitudinal axis extending along the track, and a lateral axis extending perpendicularly thereto, each of which being configured to be parallel to said gripping plane; and
   a mounting portion configured to be slidingly mounted to said track, so as to enable said movable assembly to move with respect thereto along said advancement surface, said mounting portion comprising:
      an upper sliding arrangement configured for slidingly engaging said upward facing surface of said track so as to support said movable assembly when at least one of said axes is oriented in an acute angle with respect to the horizon;
      a lower sliding arrangement configured for slidingly engaging said downward facing surface of said track, so as to thereby support said movable assembly when at least one of said axes is oriented in an obtuse angle with respect to the horizon; and
      at least one side sliding arrangement configured for slidingly engaging said sideward facing sliding surface, so as to support said movable assembly when said lateral axis is oriented in an angle with respect to the horizon.

For the purposes of the understanding of this application, the horizon is to be understood as the imaginary horizontal line where the earth and the sky appear to meet. Also, the horizon is to be understood as being in the same vertical plane as that of the longitudinal or the lateral axis when an angle between any one of the them and the horizon is referred to. Furthermore, the angles, whether acute or obtuse, are to be understood as being seen from the direction opposite to the advancement surface with respect to the movable assembly.

The movable assembly can have a moving system similar in structure and operation to any of the moving systems described above according various aspects of the presently disclosed subject matter. The gripper units can also be configured to operate in a manner similar to that of any of the gripper units escribed above according various aspects of the presently disclosed subject matter. The gripping portion can be configured to be fixedly attached to said advancement surface, optionally by virtue of vacuum.

Optionally, the at least one side sliding arrangement are two side sliding arrangement configured to be disposed on either side, and slidingly engage opposite sideward facing sliding surfaces of said track.

Optionally, the upper sliding arrangement are two upper sliding arrangement configured to be disposed on either side, and slidingly engage two separate upward facing sliding surfaces disposed on either side of said track.

Optionally, the lower sliding arrangement are two lower sliding arrangement configured to be disposed on either side, and slidingly engage two separate downward facing sliding surfaces disposed on either side of said track.

In some examples, the two portions of any or each of the upward and the downward facing sliding surfaces can be formed as single continuous surface. In other examples, the two portions of any or each of the upward and the downward facing sliding surfaces can be formed as separate portions of upward and the downward facing sliding surfaces.

Although the movable assembly is configured to constitute a part of a caterpillar apparatus having two or more such movable assemblies and thus the movable assembly can have only one side sliding arrangement to support the apparatus during tilting in one direction. During tilting in the opposite direction, the side sliding arrangement of the other assembly can support the whole apparatus. In some examples, the single side sliding arrangement can be disposed between a width of the track of the movable assembly to support the movable assembly and the apparatus during tilting in any direction. In some examples, the upper, lower, and side sliding arrangement can be constituted by a single sliding arrangement having portions supporting the track in each of its orientations. Optionally, the side sliding arrangement is disposed laterally and between said lower and upper sliding arrangements.

For the purposes of understanding of this application, the term support is to be understood as carrying the weigh and/or to hold firmly in place. For instance, the sliding arrangement supporting the track is to be understood as the sliding arrangement configured to firmly hold the track in place and to bear at least half of the weight of the movable assembly if the sliding arrangement were the only thing holding the movable assembly.

Optionally, the mounting portion further comprises a support structure on which said lower and upper sliding arrangements are disposed. The side sliding arrangement can also be disposed on said support structure. In some examples, the upper, lower, and side sliding arrangements can be fixedly disposed on said support structure.

Optionally, the mounting portion comprises at least one support element connected to said gripping portion and slidingly mounted to said support structure, configured to enable transmission of load forces therethrough, at least from said side sliding arrangement to said gripping portion, so as to facilitate said support for said movable assembly.

Optionally, the downward facing sliding surface defines a sliding path for said gripper units along said track, and said gripping portion of each of said units is movable with respect to said mounting portion thereof, perpendicularly to said sliding path.

Optionally, the mounting portion further comprises an auxiliary sliding arrangement movable with respect to at least said lower sliding arrangement, said auxiliary sliding arrangement being slidingly engageable with an auxiliary sliding surface of the track, spaced to a varying distance from said downward facing sliding surface, said auxiliary sliding arrangement being connected to said gripping portion so as to move said gripping portion with respect to said downward facing sliding surface, as its respective unit moves along said track, in response to the variation in said distance between said first and second sliding surfaces. The auxiliary sliding arrangement can be mounted on said support element.

Optionally, the gripper unit further comprises a biasing member disposed between said gripping portion, and said lower sliding arrangement, said biasing member being configured to bias said gripping portion away from said lower sliding arrangement. The auxiliary sliding arrangement can be connected to said gripping portion such that it is urged by said biasing member towards tight engagement with said auxiliary sliding surface, thereby enabling said auxiliary sliding arrangement to follow a curvature of said auxiliary sliding surface.

According to still further aspect of the presently disclosed subject matter, there is provided a caterpillar assembly movable on a non-horizontal advancement surface, said assembly comprising:
a track formed with a first sliding surface and a second sliding surface spaced from said first sliding surface to a distance varying along the length of the track;
a plurality of units mounted to said track and successively movable therealong to facilitate advancement of said movable caterpillar assembly on said advancement surface, each of said units comprising:
a mounting portion comprising a first sliding arrangement in sliding engagement with said first sliding surface, and a second sliding arrangement in sliding engagement with said second sliding surface;
an engaging portion engageable with said advancement surface and operatively connected to said second sliding arrangement, said engaging portion being movable with respect to said mounting portion as its respective unit moves along said track, in response to the variation in said distance between said first and second sliding surfaces.

Optionally, the caterpillar assembly, the track, and the unit can be same as the movable assembly, the track, and the gripper unit, respectively, and can operate in the same manner as those of the previous aspect. In some examples, the caterpillar assembly, the track, and the unit can be realized in a different manner and with different structure as compared to the movable assembly.

Optionally, the engaging portion comprises an engaging face defining an engaging plane coinciding with said moving surface during engagement of said engaging portion therewith, and said track comprises a central reference plane, disposed above and parallel to said engaging plane during said engagement, dividing said track to an upper and lower portions, and wherein during said movement of said units along said track, each of which flips between a lower side and an upper side of the central reference plane, at least twice, at two respective flipping areas on the track, the two flipping areas being symmetrically disposed on either side of a central crossing plane defined perpendicularly to said central reference plane.

The unit moves along the track and on the lower portion of track can have different locations. Each of these locations have a different distance between the first and the second sliding surfaces. At a first location of the lower portion of the track disposed proximal to one of said flipping areas with respect to said central crossing plane, said second sliding surface is spaced to a first distance from said first sliding surface, and at a second location of the lower portion of the track disposed further from said one of said flipping areas than said first location, said second sliding surface is spaced from said first sliding surface to a second distance being smaller than said first distance. The one of said flipping areas, can be either one of said flipping areas.

Optionally, at said lower portion of said track, said first surface comprises a planner portion intersecting with said central crossing plane, and an inclined portion adjacent said one of said flipping areas, and wherein said first location is disposed at said inclined portion, and said second location is disposed at said planner portion.

At a third location of the lower portion of the track disposed at said planner portion of the first surface, adjacent said inclined portion thereof, said second sliding surface is spaced to a third distance from said first sliding surface, said third distance being greater than said second distance, yet equal to or smaller than said first distance. In some examples, the third distance can be smaller than the first distance.

At a fourth location of the lower portion of the track disposed at said planner portion of the first surface, disposed closer to said central crossing plane than said second location, said second sliding surface is spaced to a fourth distance from said first sliding surface, said fourth distance being greater than said second distance, yet equal to or smaller than said first distance.

Optionally, the distance between the first and second sliding surfaces gradually decreases from said first location to said second location. Optionally, the distance between the first and second sliding surfaces remains constant throughout said inclined portion.

In some examples, during the operation of the caterpillar assembly, when the unit moves along the track and crosses the flipping area, and arrives at the first location, the unit remains closer to the track by virtue of the large first distance between the first sliding surface and the second sliding surface. The unit remains closer to the track until it reaches the second location where the engaging face becomes parallel to the advancement surface (not shown). This is important because if the unit is distant from the track (as it is at the second location), the engaging face (or at least a corner thereof) can possibly hit the advancement surface during transition of the unit from the inclined portion to the planner portion. The variation in distance enables the smooth movement of the unit along the track during operation of the caterpillar assembly.

Once the unit reaches the second location, the engaging portion moves further from the track by virtue of the second distance being smaller than the first distance, and the engaging face engages the advancement surface. In some examples, the unit is a gripper unit and grips the advancement surface upon reaching at the second location. As described in above aspects, with respect to the moving system, the track is then moved with respect to the fixed unit. As the track moves and the unit reaches the fourth location, the fourth distance being greater than the second distance causes the track to move with respect to the engaging portion and towards the engaging portion, thereby bringing the track and thus the whole caterpillar assembly closer to the advancement surface thereby providing more stability to the caterpillar assembly with respect to the advancement surface.

Optionally, unit is constituted by a gripper unit according to any one of aspects described above.

According to still further aspect of the presently disclosed subject matter, there is provided a gripper unit for use in a caterpillar assembly according to any one of the aspects described above.

According to still further aspect of the presently disclosed subject matter, there is provided track for use in a caterpillar assembly according to any one of the aspects described above.

Further aspects of the presently disclosed subject matter are described below with reference to the accompanying drawings.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIGS. 1A and 1B are respective perspective and side schematic views of a caterpillar assembly according to one example of the presently disclosed subject matter;

FIG. 1C is a perspective view of a caterpillar assembly, in accordance with another example of the presently disclosed subject matter;

FIG. 1D is a perspective schematic view of a modified caterpillar assembly of FIGS. 1A and 1B, according to another example of the presently disclosed subject matter, with a number of vacuum grippers removed;

FIG. 1E is a perspective view of a caterpillar assembly, in accordance with another example of the presently disclosed subject matter;

FIG. 1F is a perspective schematic view of a modified caterpillar assembly of FIGS. 1A and 1B, according to another example of the presently disclosed subject matter, with an additional track;

FIG. 1G is a perspective view of a caterpillar assembly, in accordance with another example of the presently disclosed subject matter;

FIG. 1H is a perspective schematic view of a modified caterpillar assembly of FIG. 1F, according to another example of the presently disclosed subject matter, with a number of vacuum grippers removed;

FIG. 1I is a perspective view of a caterpillar assembly, in accordance with another example of the presently disclosed subject matter;

FIG. 2A is a front schematic view of a vacuum gripper according to an example of the presently disclosed subject matter, which can be used in a caterpillar assembly according to the presently disclosed subject matter;

FIG. 2B is a perspective view of a vacuum gripper according to another example of the presently disclosed subject matter, which can be used in a caterpillar assembly according to the presently disclosed subject matter;

FIG. 2C is a perspective view of a vacuum gripper of FIG. 2B with its outer cover removed;

FIG. 3A is a perspective schematic view of a caterpillar apparatus according to an example of the presently disclosed subject matter, having two caterpillar assemblies according to the presently disclosed subject matter;

FIG. 3B is a perspective top view of a caterpillar apparatus according to another example of the presently disclosed subject matter, having two caterpillar assemblies according to the presently disclosed subject matter;

FIG. 3C is a cross sectional view of the caterpillar apparatus of FIG. 3B;

FIG. 3D is a perspective view of a pivoting system which can be used in a caterpillar apparatus according to the presently disclosed subject matter;

FIG. 4A is a schematic side view of a caterpillar assembly, according to another example of the presently disclosed subject matter;

FIG. 4B is an enlarged view of a portion of a moveable track of the caterpillar assembly of FIG. 4A;

FIG. 5 is a schematic side view of a vacuum gripper according to an example of the presently disclosed subject matter, which can be used in a caterpillar assembly according to the presently disclosed subject matter; and

FIG. 6A is a side perspective view of a movable assembly according to another example of the presently disclosed subject matter;

FIG. 6B is a front perspective view of the movable assembly of FIG. 6A;

FIG. 6C is an enlarged view of a portion of the movable assembly of FIG. 6B;

FIG. 6D is a side view of the movable assembly of FIG. 6A illustrating the movable assembly in an orientation when its longitudinal axis is oriented in an acute angle with respect to horizon;

FIG. 6E is a side view of the movable assembly of FIG. 6A illustrating the movable assembly in an orientation when its longitudinal axis is oriented in an obtuse angle with respect to horizon;

FIG. 6F is a rear perspective view of the movable assembly of FIG. 6A illustrating the movable assembly in an orientation when its lateral axis is oriented at an angle with respect to horizon;

FIG. 6G is a cross-sectional view of the movable assembly with the cross section taken in a plane perpendicular to the longitudinal axis in the view illustrated in FIG. 6B;

FIG. 6H is a front perspective of the movable assembly illustrating its gripper unit in a different location along its track as compared to that in FIGS. 6A to 6G;

FIG. 7A is side perspective view of a caterpillar assembly according to another example of the presently disclosed subject matter; and

FIGS. 7B to 7E are side views of the caterpillar assembly of FIG. 7A illustrating its units in different locations along its track.

### DETAILED DESCRIPTION OF EMBODIMENTS

A caterpillar apparatus according to the presently disclosed subject matter, can be configured for moving along on an exterior surface of a building or the like, having any orientation (inclined, vertical, horizontal), and any surface texture/quality (slippery or non-slippery) allowing a vacuum gripper to be attached thereto.

The caterpillar apparatus, according to the presently disclosed subject matter, can be used as a movable base platform for mounting thereto equipment for numerous applications. For example, by mounting a cleaning device to the caterpillar apparatus, the apparatus can be used for cleaning windows of a skyscraper, by mounting a cargo unit thereto the apparatus can be used for delivery purposes, or by mounting a rescue pod thereto the apparatus can even be used as a rescue device for rescuing people from high story buildings, e.g., in case of a fire, the apparatus along with the rescue pod may rescue people from the building by using the exterior of the building as an escape route.

In general, the caterpillar apparatus can comprise at least one caterpillar assembly with an array of vacuum grippers which are movable, by means of a moving system, so as to bring each of the grippers successively into a gripping position in which the gripper can be attached, when vacuum is applied thereto, to a surface along which the apparatus is to be moved, thereby enabling the advancement of the caterpillar apparatus along the surface. The caterpillar assembly can have any number of grippers and they can be arranged therein in any manner so that there are always at least two vacuum grippers in their gripping position.

Each vacuum gripper has a gripping face, at which the vacuum gripper is configured to be attached to a surface when vacuum is applied thereto, and a mounting portion at which the gripper is mounted to the caterpillar assembly. The caterpillar assembly thus has a surface gripping face constituted by the gripping faces of those vacuum grippers which are in the gripping position. Thus, the length of the surface gripping face of the caterpillar assembly along the direction of movement of the apparatus, depends on the number of vacuum grippers that are simultaneously in their gripping position.

To allow the successive movement of the vacuum grippers along the moving direction, the moving system of the caterpillar assembly can comprise at least one continuous/endless, i.e., closed loop, track, to which the grippers are mounted at their mounting portions. The track can be movable by at least one driving mechanism, in which case the vacuum grippers are fixedly mounted thereto so as to be movable therewith successively into their gripping positions. Alternatively, the track can be stationary, in which case the vacuum grippers are slidably mounted to the track and the assembly comprises other means for moving each vacuum gripper along the stationary track. One example of such other means is an additional, movable track parallel to the stationary track, drivable by at least one driving mechanism. The track(s) of the caterpillar assembly can have any shape. One of these shapes is an oblong shape, e.g. a rectangular or oval shape, or shape similar to a rectangle in that it has two parallel long sides and similar to oval in that it has two short curved sides, e.g., in the form of semicircles, continuously merging with the long sides.

The moving system of the caterpillar assembly can comprise, in addition to the movable track or as an alternative thereto, individual driving means associated with each of the vacuum grippers, for moving each of the grippers along the stationary track.

In case the moving system comprises the endless movable track, it can further comprise at least one gear, configured for movingly engaging the movable track operable by a driving mechanism, to move the track and thereby the vacuum grippers fixed thereto, so as to bring each gripper from one side to the other side of the central reference plane along the longitudinal reference plane. In case the caterpillar assembly comprises only one track, which is the stationary track, the moving system can comprise individual driving means for each vacuum gripper, which e.g. can comprise gears operable by driving mechanisms/motors, and the stationary track can have respective gears, or a zigzag surface to cooperate with the gears of the vacuum grippers. The gears of those vacuum grippers whose gripping faces are attached to the surface, along which the apparatus is to be moved, when rotated would cause the stationary track to be linearly displaced relative to those grippers in the direction of movement. Simultaneously, other vacuum grippers (not attached to the surface), with the operation of their gears, move along the stationary track to arrive at the gripping position.

In any case, the system of the caterpillar assembly that is responsible for moving the vacuum grippers (hereinafter ‘the moving system’) along the movement direction has to be such as to allow bringing the grippers successively into their gripping positions while making sure that there are always at least two vacuum grippers that are in such position, i.e. that there are always at least two vacuum grippers whose gripping faces define the surface gripping face of the apparatus.

The moving system of the caterpillar assembly can comprise or be associated with a rigid structure to form a structural support for the continuous track and the vacuum grippers.

To increase the overall safety during operation of the caterpillar apparatus, it is configured to ensure that vacuum is supplied simultaneously at least to two of those vacuum grippers that are in their gripping position, to make sure that gripping faces of these grippers are simultaneously attached to the surface along which the apparatus is to be moved. Thus, even though the use of one vacuum gripper may be sufficient for securing the apparatus to the surface, the at least one additional vacuum gripper can act as a backup for the former vacuum gripper, preventing the apparatus from being detached from the surface.

The caterpillar assembly can comprise a vacuum system configured to apply vacuum to selected grippers. The system can comprise a plurality of individual vacuum pumps each associated with a single vacuum gripper and configured for selectively creating vacuum therewithin. By having each vacuum gripper equipped with such individual vacuum pump, the overall safety of the apparatus is increased, e.g., by preventing it from detachment from the surface or slipping if a malfunction occurs in the vacuum pump of any other vacuum gripper. Since each vacuum gripper creates its own vacuum without being dependent on a common vacuum pump or the function of the other grippers, the overall safety of the apparatus is increased.

To further increase the overall safety and efficiency of the apparatus, each vacuum gripper can be equipped with two or more individual vacuum pumps configured for selectively creating vacuum within the gripper, thereby ensuring that each vacuum pump has a backup pump.

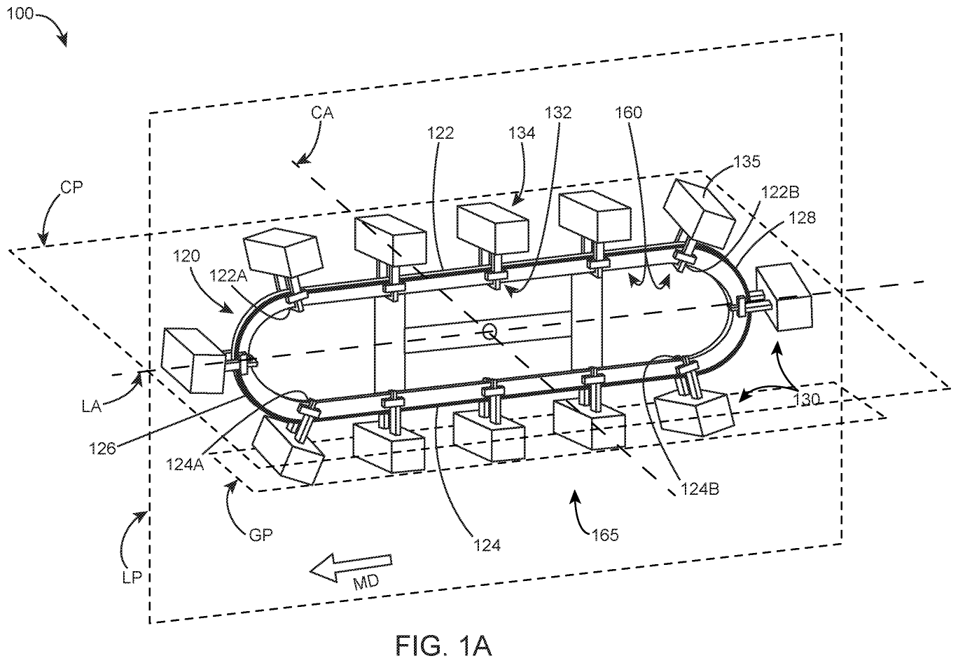

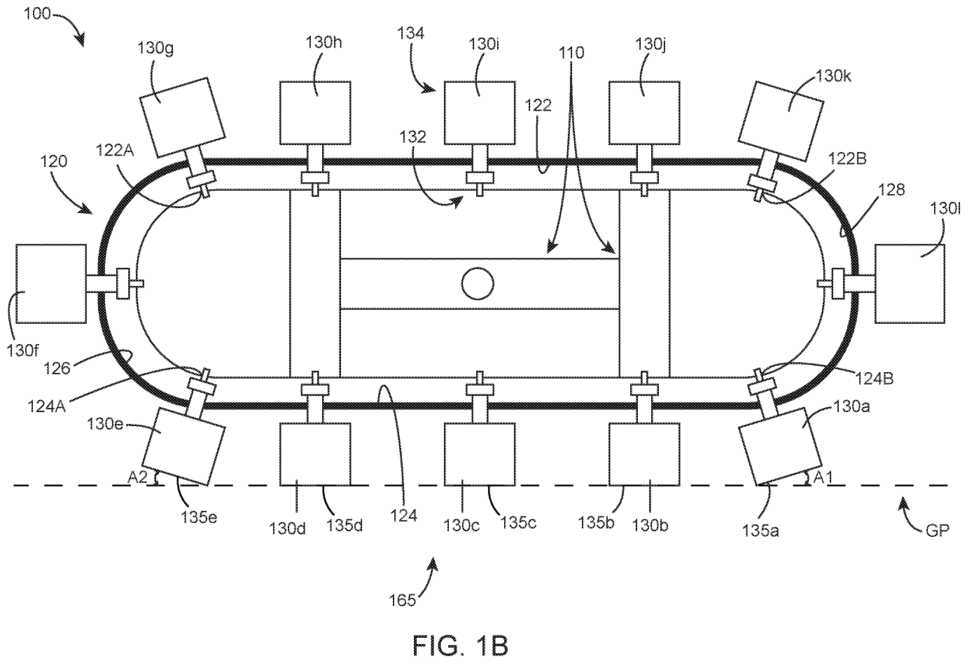

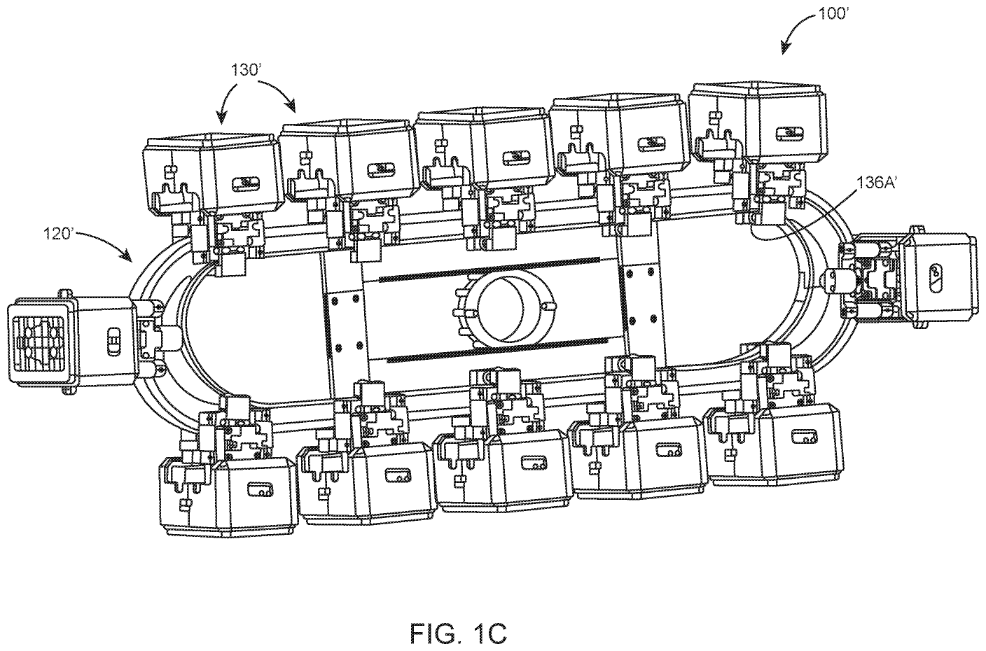

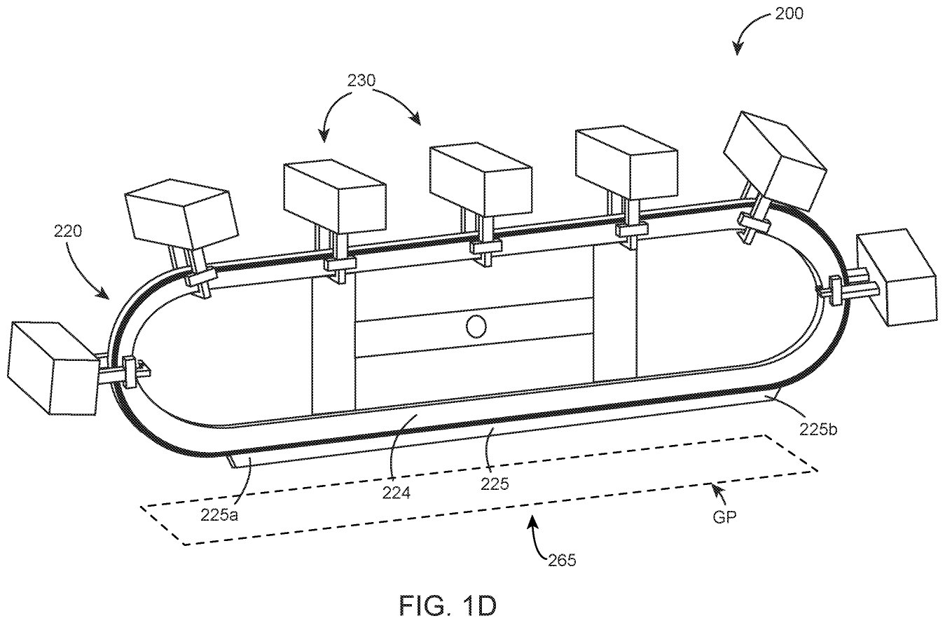

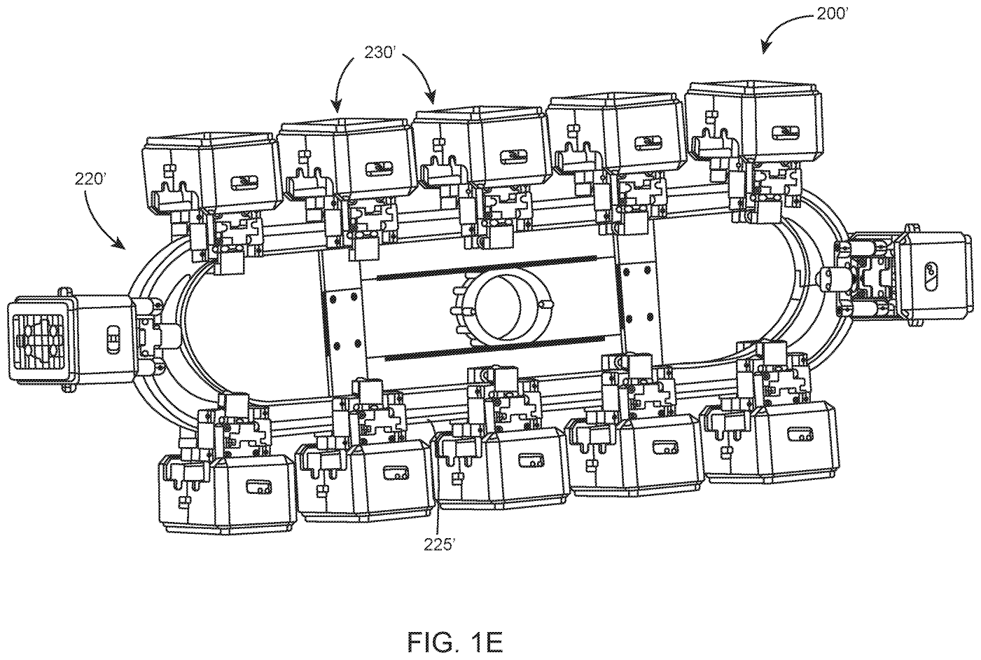

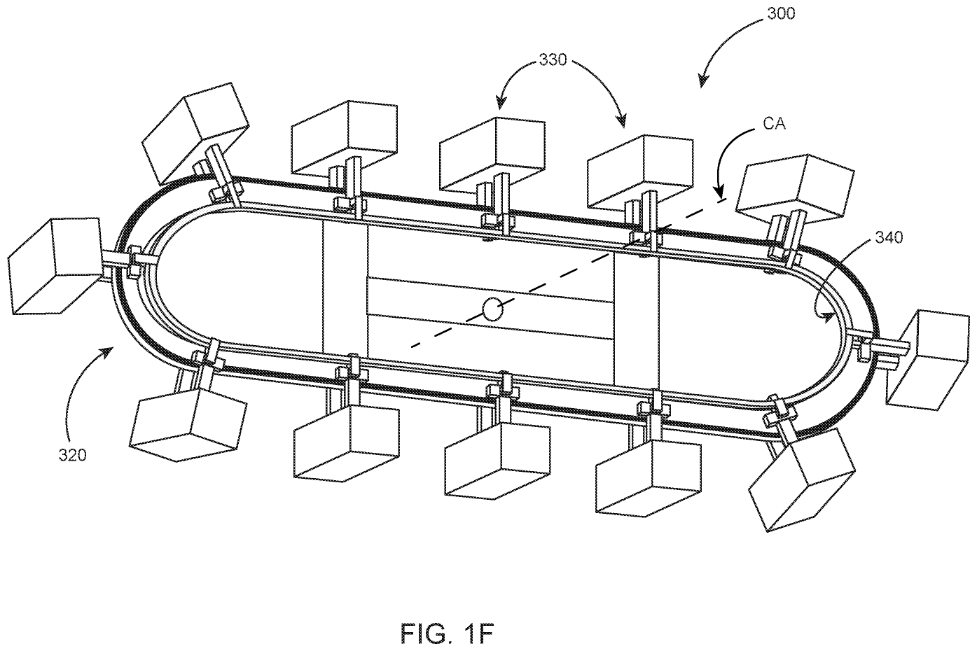

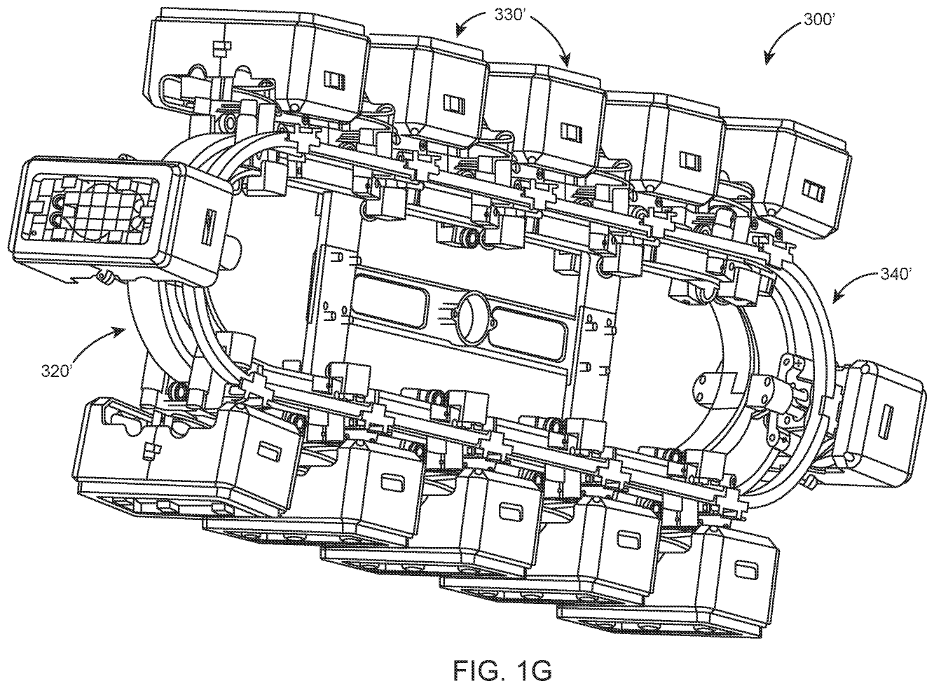

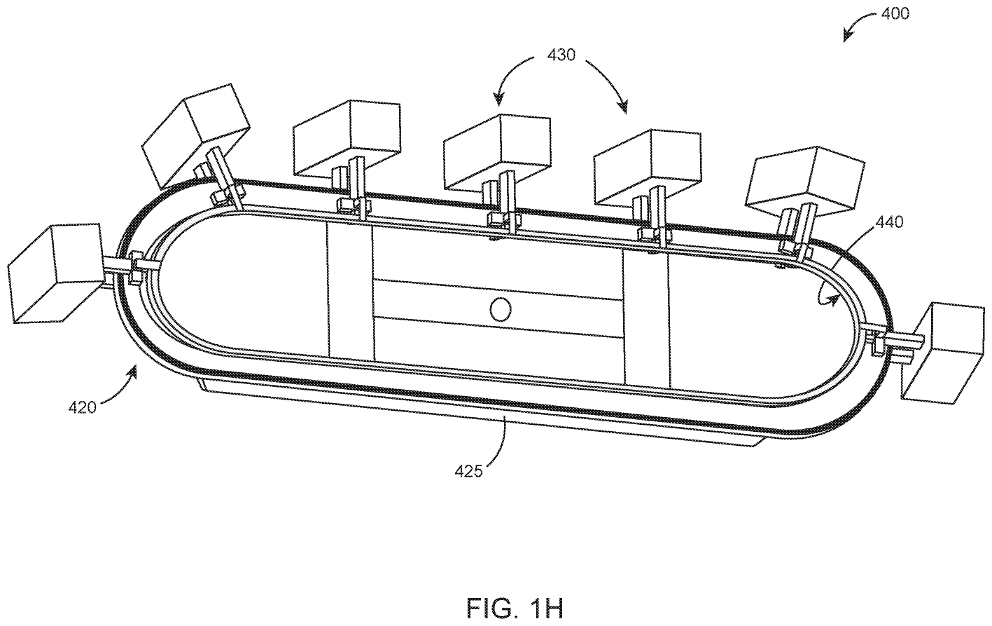

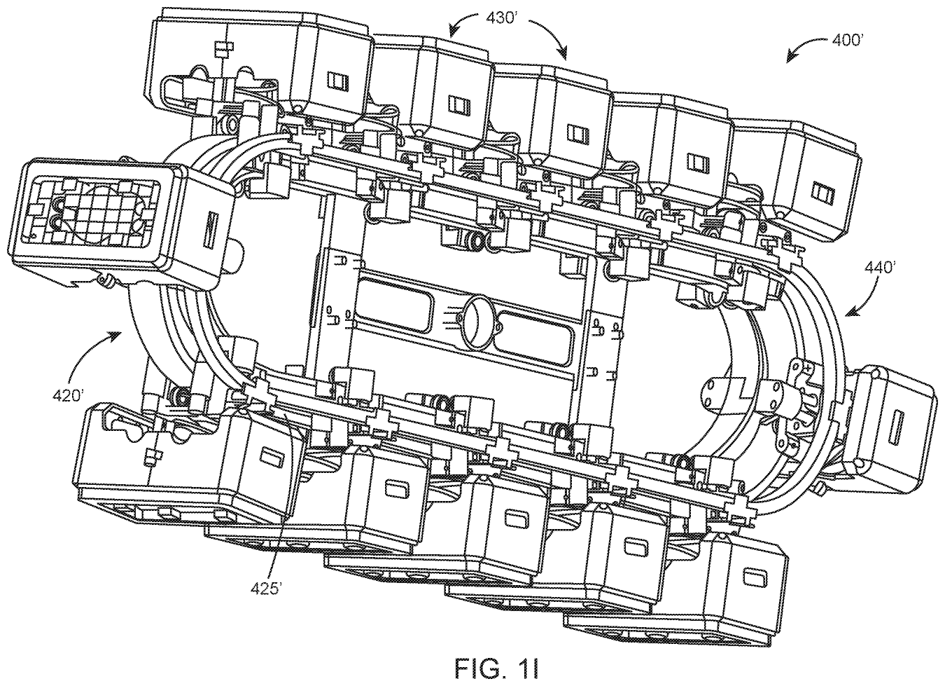

Reference is now made to FIGS. 1A and 1B schematically illustrating a caterpillar assembly 100 which can function as a single-line caterpillar apparatus according to an example of the presently disclosed subject matter, or can constitute a part of a two-line or multiple-line apparatus having two or more such assemblies, respectively.

The caterpillar assembly 100 according to the presently disclosed subject matter has a longitudinal reference plane LP comprising a longitudinal axis LA parallel to the direction along which the assembly is expected to move, and a central reference plane CP perpendicular to the longitudinal reference plane LP and comprising the longitudinal axis LA and a central axis CA perpendicular to the longitudinal axis LA.

In the caterpillar assembly 100 shown in FIGS. 1A and 1B, the longitudinal plane and axis are designated as LP and LA respectively, the central plane and axis are designated as CP and CA, respectively, and the direction of movement of the assembly is designated as MD.

As seen in FIGS. 1A and 1B, the caterpillar assembly 100 comprises a moving system with an endless/continuous/closed loop track 120, a plurality/array of vacuum grippers 130, more particularly, 130a, 130b, 130c, 130d, 130e, 130f, 130g, 130h, 130i, 130j, 130k, and 130l, connected thereto, and a rigid structure 110 securely holding the track 120 and configured for attachment thereto a base platform (not shown) constituting a part of the caterpillar apparatus and/or an exterior equipment for the transportation of which the caterpillar apparatus is to be used.

The endless track 120 of the caterpillar assembly 100 comprises a distal section 122 disposed further than the central plane CP from the surface along which the caterpillar apparatus is to be moved, a proximal section 124 disposed closer to that surface than the central plane CP, a front section 126 disposed on one side of the longitudinal plane LP, and a rear section 128 disposed on an opposite side of the longitudinal plane, behind the front section with respect to the direction MD. The distal and proximal sections of the track can extend substantially parallel to the longitudinal axis LA of the assembly, whilst the side sections can be curved with respect to the axis LA, or be vertical thereto, and be essentially shorter than the distal and proximal sections. The common areas of each of the side sections and the distal/proximal sections can be smooth, i.e., such that a tangent thereto is perpendicular to the central plane of the assembly.

The moving system of the caterpillar assembly according to the presently disclosed subject matter can thus be configured to move the vacuum grippers 130 from the distal 122 to the proximal 124 section of the track 120 via the front section 126 of the track 120 and from the proximal 124 to the distal 122 sections via the rear section 128 of the track 120.

The track 120 can constitute a part of a moving system 160 of the assembly 100, in which case it can be movable about the central axis CA, and the vacuum grippers can be fixedly mounted thereto. Alternatively, the track 120 can be stationary, and the moving system of the assembly can comprise any other suitable means for slidingly moving the vacuum grippers along the stationary track 120.

During their operation, the vacuum grippers 130 can support the assembly 100 through the stationary track 120 connecting therebetween, as the grippers 130 cling on the surface on which the assembly 100 is moving.

In the caterpillar assembly 100, the track 120 is in the form of a continuous conveyor belt having an oblong shape with elongated distal section 122 (disposed above the central plane CP in FIGS. 1A and 1B), elongated proximal section 124 (disposed below the central plane CP in FIGS. 1A and 1B), front section 126 and rear section 128 continuously merging with each of their adjacent others. More particularly, the distal and proximal sections 122 and 124 have respective front ends 122A and 124A at which the front section 126 merges with the distal and proximal sections, and respective rear ends 122B and 124B at which the rear section 128 merges with the distal and proximal sections.

Thus, the vacuum grippers 130 are movable, in the counterclockwise direction with respect to the axis CA between the different sections in that order-front-proximal-rear-distal. The direction of movement of the grippers along the distal section 122 is opposite to the expected direction of movement MD of the entire apparatus. It should be noted that the apparatus 100 can move in the opposite direction to the direction of movement MD, e.g., when the vacuum grippers 130 are moved in a clockwise direction (not illustrated).

Each of the grippers 130 has a proximal end 132 at which the gripper is mounted to the track 120 and a distal end 134 comprising a gripping face 135 of the gripper 130, which is configured to be brought into contact with a surface on which the apparatus 100 is to be moved. When the vacuum gripper 130 crosses the front end 124A of the proximal section 124 of the track during the above described movement, its gripping face is generally oriented parallel to the central plane CP of the assembly.

The gripping faces 135 of the grippers 130 disposed in their gripping positions at the proximal section of track 120 constitute a surface gripping face 165 of the caterpillar assembly 100, which in the described example, lies in a single plane parallel to the central plane CP and referred to hereinafter as a grip plane GP of the caterpillar assembly. However, this does not have to be the case.

In the described example, along the length of the proximal section of the track along the longitudinal axis LA, the number of the vacuum grippers and the spacing between them are such that three grippers, 130b to 130d, are disposed simultaneously in their gripping position in which their gripping faces 135b to 135d lie in the plane GP and constitute the surface gripping face 165. However, this does not have to be the case and the number of grippers disposed simultaneously in their gripping position can be less, i.e. two as mentioned above or more than three.

In general, the vacuum grippers in a caterpillar assembly according to the presently disclosed subject matter, can each take, during its movement, the following positions along different sections of the track: a remote position at the distal section of the track, at which the gripping face of the vacuum gripper is spaced to a maximal distance from the grip plane GP, an intermediate position at each of the front and rear sections of the track, when the gripping face of the vacuum gripper is spaced from the front and rear ends of the proximal track section, a grip entering position at the area of merger of the front section with the front end of the proximal section of the track, in which the gripping face of the vacuum gripper forms an obtuse angle, facing the track, with the grip plane GP, a plurality of gripping positions along the proximal section of the track between its front and rear ends, in which the gripping face of the vacuum gripper lies in the grip plane GP, and a grip exiting position at the area of merger of the rear end of the proximal section of the track with the rear section of the track, in which the gripping face of the vacuum gripper forms an obtuse angle, facing the track, with the grip plane GP.

In the present example, the positions of the vacuum grippers in the state of the assembly 100 as shown in FIGS. 1A and 1B, are as follows:
the vacuum grippers 130b to 130d are each in the gripping position, in which their gripping faces 135b to 135d lie in the plane GP, the gripper 130d being in the first gripping position adjacent the front end 124A of the proximal section 124 of the track, and the gripper 130b being in the last gripping position adjacent the rear end 124B of the proximal section 124 of the track;
the vacuum gripper 130a is in the grip exit position adjacent the rear end 124b of the proximal section 124 of the track, in which its gripping face 135a forms an angle A1 with the grip plane GP;
the vacuum grippers 130g to 130k are in their remote positions at the distal section of the track, in which their gripping faces are spaced to a maximal distance from the grip plane GP;
the vacuum grippers 130f and 130l are in their intermediate positions at the respective front and rear sections of the track, in which their gripping faces are spaced from the grip plane GP to a distance smaller than the above maximal distance; and
the vacuum gripper 130e is in the grip entering position adjacent the front end 124A of the proximal section 124 of the track, in which its gripping face 135e forms an angle A2 with the grip plane GP;

FIG. 1C illustrates a caterpillar assembly 100′ showing more details about the structural construction of the caterpillar assembly, according to an example of the presently disclosed subject matter. As can be seen in FIG. 1C, the caterpillar assembly 100′ comprises a track 120′ having vacuum grippers 130′ positioned therealong. The caterpillar assembly 100′ comprises the same components as that of the caterpillar assembly 100, with a difference between positions of the vacuum grippers, and the description above relating to the caterpillar assembly 100 shown in FIGS. 1A and 1B, and all its components is fully applicable (apart from the positions of the vacuum grippers) to the caterpillar assembly 100′ shown in FIG. 1C and all its components. According to the example illustrated in FIG. 1C, the track 120′ is a stationary track and the vacuum grippers 130′ are slidingly mounted thereto. The moving system, in this case, comprises the track 120′, gears 136A′ associated with each vacuum gripper 130′, corresponding gears (not shown) associated with the track 120′, a driving mechanism/motor (not shown) configured to individually rotate the gears of each of the vacuum grippers and/or the track 120′. In some examples, the moving system can comprise an individual driving mechanism/motor associated with gears of each of the vacuum grippers. In some examples, the gears of the track 120′ can be a zigzag surface of the track constituting the gears corresponding to the gears of the vacuum grippers.

The rotation of the gears 136A′ of the vacuum grippers 130, which are not attached to the surface on which the assembly is to be moved, causes those grippers to move along the track 120′. The rotation of the gears 136A′ of the vacuum grippers 130, which are attached to the surface on which the assembly is to be moved, causes the stationary track 120′ to move in the direction of movement, thereby forwarding the assembly 100′.

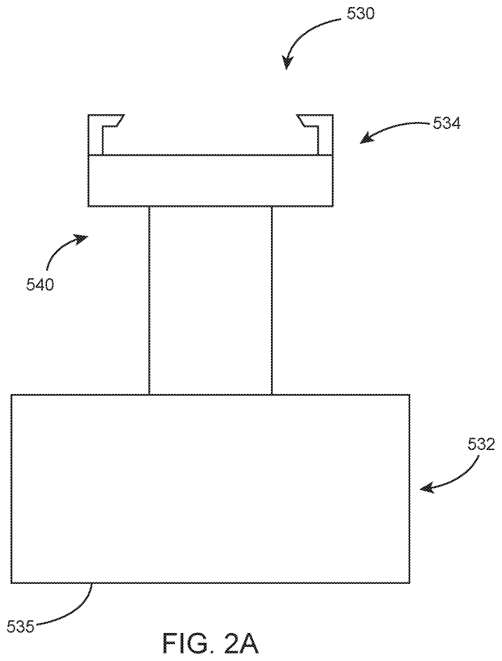

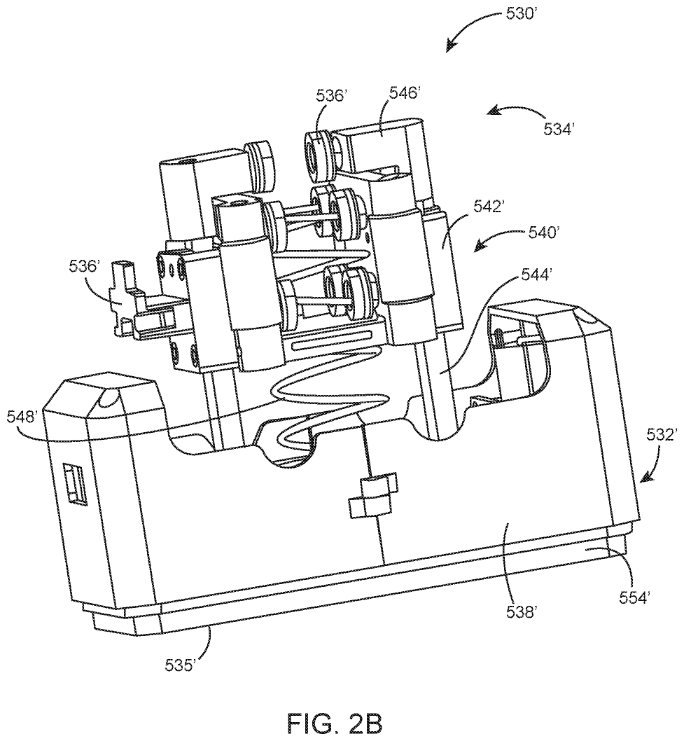

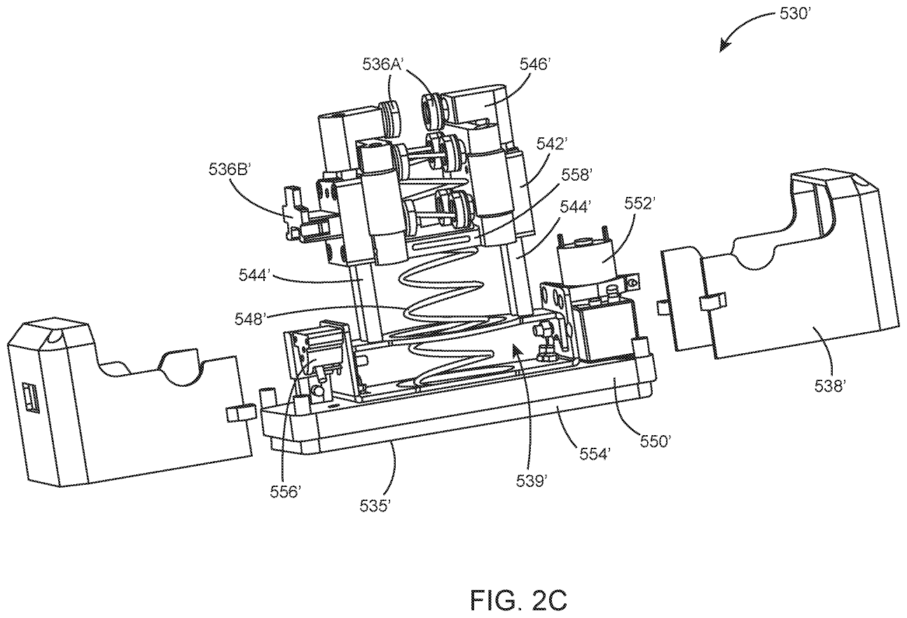

The caterpillar apparatus according to the presently disclosed subject matter further comprises a vacuum system, which can be configured so as to make sure that vacuum is applied to each vacuum gripper when it takes the grip entering position or when it faces the grip plane, and it can be maintained within the vacuum gripper until the vacuum is released. The vacuum system can also be configured to release the vacuum maintained when the vacuum gripper reaches the rear end of the proximal section of the track. In the present example, the vacuum system comprises a plurality of vacuum pumps, each associated with or disposed within a corresponding vacuum gripper. Some examples of such vacuum gripper are described below with reference to FIGS. 2A to 2C.

To save energy and to further increase the overall safety during operation of the caterpillar apparatus, each vacuum gripper can be configured for maintaining the vacuum created therein after termination of operation of its vacuum pump, e.g., at least during the time when the gripping face of the vacuum gripper is to be attached to the surface along which the apparatus is to be moved. Accordingly, each vacuum gripper is configured to have the following operational modes: a suction mode when the vacuum is created by the vacuum pump and an optional vacuum mode when the vacuum is maintained after the termination of operation of the vacuum pump, and a non-operational mode when the vacuum pump is not operated, and the vacuum is released from the vacuum gripper. Thus, each gripper is configured to be in its suction mode or vacuum mode in at least one gripping position thereof. Each vacuum gripper that can be used in a caterpillar assembly according to the presently disclosed subject matter, can comprise or have associated therewith a pump manipulator configured to initiate the operation of the pump once the vacuum gripper reaches a pre-determined starting position, e.g. the grip entering position or the first gripping position adjacent the front end of the proximal section of the track. Accordingly, the caterpillar assembly can comprise at least one starting position indicator, e.g., disposed in the vicinity of the front end of the proximal section of the track, configured for signaling to the pump manipulator of each gripper when the gripper reaches the predetermined starting position in which it has to enter its suction mode. The starting position indicator can be any one of a visual, a mechanical and/or an electronic switch and/or indicator configured to signal the pump manipulator. The pump manipulator can be an optic/image processing unit, a mechanic trigger, a laser sensor or any other sensor which can receive feedback from the starting position indicator to initiate the operation of the pump.

Each vacuum gripper can further comprise or have associated therewith a vacuum releaser which is configured to release the vacuum maintained in the gripper once the vacuum gripper reaches a predetermined finishing position. Accordingly, the caterpillar assembly can comprise at least one finishing position indicator, e.g., disposed in the vicinity of the rear end of the proximal section of the track, configured for signaling to the vacuum releaser of the gripper when the gripper reaches the predetermined finishing position, in which vacuum should be released from the vacuum gripper to release grip thereof from the surface, thereby enabling the vacuum gripper to be moved to the rear section of the track. Similarly to the starting position indicator, the finishing position indicator can be any one of a visual, a mechanical and/or an electronical switch and/or indicator, configured to trigger the vacuum releaser. The vacuum releaser can be an optic/image processing unit, a mechanic trigger, a laser sensor or any other sensor which can receive feedback from the finishing position indicator to release the vacuum maintained in the vacuum gripper.

Additionally, each vacuum gripper can comprise at least one sensor configured to indicate whether the vacuum gripper is in an operational mode, i.e., suction mode or vacuum mode, or in a non-operational mode, and, optionally, its malfunction. This indication may help assess the overall safety of the apparatus indicating at each moment the number of vacuum grippers that are attached to the surface.

FIG. 1D schematically illustrates a caterpillar assembly 200 similar to the caterpillar assembly 100 described above and having a track 220 and vacuum grippers 230 (with some vacuum grippers removed for the purpose of better illustration of elements of the assembly 200), with a difference between them being in that the track 220 has a position indicator 225 in the form of an elongated protrusion protruding outwardly from the proximal section 224 of the track 220 towards the surface gripping face and extending along the grip plane GP to a length corresponding to the number of vacuum grippers 230 that can simultaneously be in their gripping position.

The position indicator 225 has a start indication area 225a allowing the indicator 225 to function as a starting position indicator, and an end indication area 225b allowing the indicator 225 to function as a finishing position indicator, such that each time a vacuum gripper 230 comes in contact with or arrives at a position on the track common with the start indication area 225a, the pump manipulator of the vacuum gripper causes the vacuum pump of the vacuum gripper to operate and the gripper thus to enter its suction mode, optionally succeeded with the vacuum mode, and when the vacuum gripper comes in contact with or arrives at a position on the track common with the end indication area 225b, the vacuum releaser is caused to release vacuum from the vacuum gripper thereby bringing the vacuum gripper into the non-operational mode, where vacuum is released.

The position indicator 225 can trigger the pump manipulator or the vacuum releaser by a respective front or end distance sensing device, such as an optic/laser, a mechanic or an electronic sensor. The distance sensing device (detailed hereinbelow with respect to FIGS. 2B and 2C), can ‘watch’ the start area 225a or the end area 225b of the position indicator 225 and sense the change in its state when one of the vacuum grippers has contacted this area, or is a predetermined distance from this area, so as to trigger the pump manipulator or the vacuum releaser accordingly, which thus causes the vacuum gripper to enter its suction mode or vacuum release mode, respectively. Optionally, once vacuum is created within the vacuum gripper in its suction mode, it enters its vacuum mode and the vacuum is maintained therewithin. The vacuum mode can be triggered by a pressure sensor indicating that a predetermined negative pressure is achieved within the gripper. The predetermined negative pressure can be, for example, any pressure below −0.2 bar, and may be sufficient to secure the caterpillar apparatus to the surface.

To increase the overall safety of operation of the assembly, in the present example the position indicator 225 extends along a majority of the proximal section of the track 220. Thus, if, for any reason, the vacuum gets released from the vacuum gripper while it is still required to be secured to the surface, the position indicator 225 acting as the position indicator, signals to reinitiate the suction mode of the vacuum gripper. In this example, the position indicator 225 extends along the entire proximal section 224 of the track 220 that faces the surface gripping face 265 in a continuous manner. Alternatively, the position indicator can comprise a plurality of discrete protrusions.

In the present example, the track 220 is a stationary track. In other examples, the track 220 can be a movable track or a stationary track, and the position indicator can be realized by other means so as to indicate the position of the grippers with respect to the rigid structure and/or the moving system of the assembly. In another example (not shown), e.g., when the track 220 is a movable track, a position indicator similar to the position indicator 225 described hereinabove, or different therefrom, can be mounted to any stationary part of the assembly.

FIG. 1E illustrates a caterpillar assembly 200′ showing more details about the structural construction of the caterpillar assembly, according to an example of the presently disclosed subject matter. As can be seen in FIG. 1E, the caterpillar assembly 200′ comprises a track 220′ having positioned therealong vacuum grippers 230′ and having a position indicator 225′. The caterpillar assembly 200′ comprises similar components as that of the caterpillar assembly 200, with a difference being in the number of vacuum grippers illustrated, and the description above relating to the caterpillar assembly 200 shown in FIG. 1D, and all its components is fully applicable (apart from the positions of the vacuum grippers) to the caterpillar assembly 200′ shown in FIG. 1E and all its components.

As mentioned above, a caterpillar assembly according to the presently disclosed subject matter, can comprise a stationary track to which the vacuum grippers are slidably connected, and a movable track to which the vacuum grippers are fixedly mounted for being moved therewith between the positions described above, while staying slidably connected to the stationary track. In this case, the two tracks can both be of an endless type and be disposed adjacent to each other, have the same shape and be oriented in the same manner.

FIG. 1F schematically illustrates a caterpillar assembly 300 having similar components as the assembly 100 of FIGS. 1A and 1B, but having two tracks, one—a movable track 340, to which the vacuum grippers 330 are fixedly mounted to be movable therewith, and the other one—a stationary track 320, to which the vacuum grippers 330 are slidingly connected for providing structural support and/or maintaining their desired orientation during the movement. The description above relating to the caterpillar assembly 100 shown in FIGS. 1A and 1B, and all its components is fully applicable to the caterpillar assembly 300 shown in FIG. 1F and all its components, except for that the description above relating to the sections of the track 120 is applicable to the sections of the tracks 320 and 340.

The movable track can be configured to be rotated about the central axis CA of the caterpillar assembly by a moving system according to the presently disclosed subject matter. The moving system can comprise one or more wheels and/or gears configured to be rotated by a common driving system or a respective driving mechanism/motor associated with each of the wheels/gears. In some examples, the moving system can comprise a central hub and one or more mechanical arms configured for rotating the movable track about the central axis.

FIG. 1G illustrates a caterpillar assembly 300′ showing more details about the structural construction of the caterpillar assembly, according to an example of the presently disclosed subject matter. As can be seen in FIG. 1G, the caterpillar assembly 300′ comprises a movable track 340′ having vacuum grippers 330′ fixedly mounted therewith, and a stationary track 320′, to which the vacuum grippers 330′ are slidingly connected. The caterpillar assembly 300′ comprises similar components as that of the caterpillar assembly 300, with a difference between positions of the vacuum grippers, and the description above relating to the caterpillar assembly 300 shown in FIG. 1F, and all its components is fully applicable (apart from the positions of the vacuum grippers) to the caterpillar assembly 300′ shown in FIG. 1G and all its components.

Whilst the caterpillar assembly 200 described with respect to FIG. 1D has a stationary track 220, the description of the stationary track 220 including that of the position indicator 225 and its operation, is fully applicable to a caterpillar assembly, where the track is a movable track and the vacuum grippers are movable by the movable track. For instance, FIG. 1H schematically illustrates a caterpillar assembly 400 having similar components as the assembly 200 of FIG. 1D, but having two tracks, one-a movable track 440, to which the vacuum grippers 430 are fixedly mounted to be movable therewith, and the other one-a stationary track 420, to which the vacuum grippers 430 are slidingly connected, and which comprises the position indicator 425 corresponding to the position indicator 225 of the track 220 of FIG. 1D. The description above relating to the caterpillar assembly 200 shown in FIG. 1D, and all its components is fully applicable to the caterpillar assembly 400 shown in FIG. 1H and all its components, except for that the description relating to the sections of the track 220 is applicable to the sections of the tracks 420 and 440.

FIG. 1I illustrates a caterpillar assembly 400′ showing more details about the structural construction of the caterpillar assembly, according to an example of the presently disclosed subject matter. As can be seen in FIG. 1I, the caterpillar assembly 400′ comprises a movable track 440′ having vacuum grippers 430′ fixedly mounted therewith, and a stationary track 420′, to which the vacuum grippers 430′ are slidingly connected and are supported thereby and which comprises a position indicator 425′. The caterpillar assembly 400′ comprises similar components as that of the caterpillar assembly 400, with a difference being in the number of vacuum grippers illustrated, and the description above relating to the caterpillar assembly 400 shown in FIG. 1H, and all its components (apart from the positions of the vacuum grippers) is fully applicable to the caterpillar assembly 400′ shown in FIG. 1I and all its components.

As mentioned above, each vacuum gripper has the mounting portion, at which it is mounted with the caterpillar assembly. For this purpose, the mounting portion can enable the vacuum gripper to be slidingly mounted to a stationary track and/or fixedly mounted to a movable track. The vacuum gripper can be provided with an adjusting device configured for enabling adjustment of the distance between its gripping face or gripping portion, and the track, and/or orientation thereof at an adjustable angle with respect to the central plane CP. The adjustment of the distance and/or the orientation angle, can enable the caterpillar apparatus to advance over an uneven surface, such as an inclined surface and/or a surface which comprises elevations, depressions, steps or ditches.

When the surface along which the caterpillar assembly or the caterpillar apparatus is to be moved is not ideally planar, the vacuum grippers are configured to adjust a distance between their gripping faces and the track, thus rendering the surface gripping face of the caterpillar assembly to have a non-planar configuration. In this case, the grip plane of the caterpillar assembly will be defined by the gripping face(s) of that/those vacuum gripper(s) disposed in their gripping position, which is at a maximal distance from the track.

FIG. 2A schematically illustrates a vacuum gripper unit 530, which can be used in any caterpillar assembly described above or any other caterpillar assembly according to the presently disclosed subject matter. The vacuum gripper unit 530 comprises a gripping portion 532 configured to be attached to the surface on which the caterpillar assembly is to be moved, an opposite mounting portion 534 by which the gripper 530 can be mounted to a track (fixedly or slidingly) of the caterpillar assembly, e.g., via at least one attachment element (described hereinbelow with reference to FIGS. 2B and 2C), and an adjusting device 540 configured for connecting the two portions. The adjusting device 540 is configured for enabling adjustment of the distance between the gripping portion 532 and the track (not shown). For example, adjusting device 540 can comprise a spring, a piston, other distance adjustable element and/or any combination thereof, enabling the adjustment of distance between the gripping face 535 of the vacuum gripper 530 and the track. The adjusting device 540 is configured for orienting the vacuum gripper unit 530 in general, and/or the gripping portion 532 in particular, at an adjustable angle with respect to the central plane CP of the caterpillar assembly. The adjustment of the distance and/or the orientation angle of the vacuum gripper unit in general and/or the gripping portion in particular, can enable the caterpillar apparatus to advance over an uneven surface, such as an inclined surface and/or a surface which comprises elevations, depressions, steps or ditches.

As mentioned above, a vacuum gripper that can be used with caterpillar assemblies in any of the above-described examples of a caterpillar apparatus according to the presently disclosed subject matter, as well as any other such apparatus, can have any construction of its gripping portion allowing it to be securely attached to a surface along a pre-determined area defined by a surface area of the gripping face of the gripper.

Some examples of such vacuum gripper are illustrated in FIGS. 2B and 2C hereinbelow. It needs to be indicated that the vacuum gripper described hereinbelow can have a gripping portion similar, and that can operate similarly, to a vacuum apparatus described in WO2019215722, which description is incorporated herein by reference, with a main difference being in that the vacuum apparatus described in the above publication is configured for attaching to an object to be carried thereby, whilst the presently disclosed vacuum gripper has an adjusting device and/or a mounting portion so as to be used in a caterpillar assembly.

FIGS. 2B and 2C illustrate a vacuum gripper unit 530′ showing more details about the structural construction of the vacuum gripper, according to an example of the presently disclosed subject matter. The vacuum gripper 530′ comprises a gripping portion 532′ configured to be attached, via its gripping face 535′, to the surface on which the caterpillar assembly is to be moved, and an opposite mounting portion 534′ configured to be mounted to the track of the caterpillar assembly, e.g. via at least one attachment element. The vacuum gripper 530′ further comprises an adjusting device 540′ configured to facilitate an adjustment of distance and/or orientation angle of the vacuum gripper 530′ in general and the gripping portion 532′ in particular with respect to the track and/or the central plane CP of the caterpillar assembly. The vacuum gripper 530′ further comprises a first attachment element 536A′ in the form of gears/wheels, mounted to the mounting portion 534′ and configured to be slidingly mounted to the track in case the track is a stationary track. In case the track is a movable track, a second attachment element 536B′ of the vacuum gripper 530′, mounted to the mounting portion 534′ can be used to fixedly mount the vacuum gripper 530′ to the movable track. The vacuum gripper 530′ can further comprise, or can have associated therewith, a driving mechanism/motor (not shown) configured for moving the gears 536A′. Further either or both of the attachment elements 536A′ and 536B′ can be configured for detachably mounting the vacuum gripper with the track.

The vacuum gripper 530′ further comprises an outer cover 538′, which has been removed in FIG. 2C to show internal components of the vacuum gripper 530′, the gripping portion 532′ and the adjusting device 540′.

As can be seen in FIG. 2C, the adjusting device 540′ has a body 542′ connected via proximal ends of legs 544′ to a base 539′ of the vacuum gripper 530′. The legs 544′ have distal ends thereof connected, via connectors 546′ of mounting portion 534′, to the wheels 536A′. In the illustrated example, the legs 544′ are configured in the form of telescopic rods and are configured to telescopically change their respective lengths. The body 542′ via mounting portion 534′ is connected thereto by the second attachment element 536B′. The adjusting device 540′ comprises a spring 548′ having a proximal end thereof connected to the base 539′ of the vacuum gripper 530′ and a distal end thereof connected to the body 542′ of the adjusting device 540′. For the purpose of adjusting the distance between the attachment elements 536A′, 536B′ and the gripping face 535′, the spring 548′ can be compressed and stretched by an actuation mechanism (not shown) controlled by a sensor, configured to sense if the gripping face 535′ touches a surface (the surface on which the assembly is to be moved), and a controller (not shown). Simultaneously, the legs 544′ decrease (while the spring is compressed) and increase (while the spring is stretched) their respective lengths telescopically, thereby changing the distance between the attachment elements 536A′, 536B′ and the base 539′ of the vacuum gripper 530′. For the purpose of changing the orientation of the gripper 530′, the legs 544′ can be actuated, for example by the controller, to have different lengths with respect to each other based on the orientation that is to be achieved, and the spring can be configured to flex accordingly. Additionally, for the purpose of changing the orientation of the gripping face 535′ with respect to the central plane CP of a caterpillar apparatus, the legs 544′ can be connected to the base 539′ such that a degree of freedom is left enabling the gripping face to change its angle, e.g. tilt, with respect to the grip plane.

The vacuum gripper 530′ further comprises a suction plate 550′ configured, in conjunction with a vacuum pump 552′, to create a vacuum between itself and the surface on which the assembly is to be moved. The suction plate 550′ has a sealing rubber 554′ positioned along a periphery of the face of the suction plate 550′ facing away from the track, when the vacuum gripper 530′ is mounted to the track. The sealing rubber 554′ defines the gripping face 535′ of the vacuum gripper 530′. When the vacuum is generated within the vacuum gripper 530′, i.e., between the suction plate 550′ and the surface on which the assembly is to be moved, the sealing rubber 554′ attaches with the surface.

Whilst the vacuum pump 552′ has been described above as a part of the vacuum gripper 530′, the vacuum pump can be external to the vacuum gripper while being associated therewith and configured to create negative pressure therewithin.

The vacuum gripper 530′ further comprises a vacuum switch 556′ configured to switch the vacuum gripper 530′ between its non-operational mode (when there is no vacuum in the gripper) and various operational modes as detailed hereinabove with respect to FIGS. 1A and 1B. The vacuum switch 556′ is configured to be controlled by the controller (not shown) based on a distance sensing device 558′ configured with the vacuum gripper 530′. The distance sensing device 558′ senses the position of the vacuum gripper along the track, and signals, via the controller, the vacuum switch 556′ to operate the vacuum pump 552′. Upon sensing the vacuum gripper reaching its predetermined starting position (as detailed hereinabove with respect to FIGS. 1A and 1B), the distance sensing device 558′ signals the vacuum switch 556′ to function as a pump manipulator to initiate the operation of the vacuum pump 552′ thereby causing the vacuum gripper 530′ to enter into its suction mode. Upon sensing the vacuum gripper reaching its predetermined finishing position (as detailed hereinabove with respect to FIGS. 1A and 1B), the distance sensing device 558′ signals the vacuum switch 556′ to function as a vacuum releaser to release the vacuum from within the gripper 530′.

Whilst the distance sensing device has been shown in FIG. 2C positioned on an inner surface of the body 542′, it can be positioned at any location with respect to the vacuum gripper 530′ such that it can ‘watch’ the position indicator of the track to sense the position of the vacuum gripper along the track.

In the illustrated example, the adjusting device has been described as operating with the help of a spring and telescopic rods. In other examples, the adjusting device can comprise either of a spring, a telescopic rod, a piston, a hydraulic mechanism, combinations thereof, or any other mechanism capable of adjusting the distance and/or orientation of the vacuum gripper with respect to the track.

As mentioned above, a caterpillar apparatus according to the presently disclosed subject matter can comprise two or more caterpillar assemblies of the kind described above. Some examples of such assemblies are presented in FIGS. 1A to 1I.

In general, a caterpillar apparatus according to the presently disclosed subject matter can comprise any of the exemplary caterpillar assemblies 100, 100′, 200, 200′, 300, 300′, 400, 400′ described above according to various examples of the presently disclosed subject matter, or any other such caterpillar assembly. In some examples, the caterpillar apparatus can comprise assemblies of different kinds, for example, one assembly can be similar to one of the caterpillar assemblies 100, 100′, 200, 200′, 300, 300′, 400, 400′ while the other assembly can be similar another one of the caterpillar assemblies 100, 100′, 200, 200′, 300, 300′, 400, 400′. The caterpillar assemblies of the caterpillar apparatus can be connected, via their respective rigid structures forming structural supports of the assemblies, together by a common base, i.e., a base of the caterpillar apparatus, and can have an equal number of vacuum grippers such that at each moment a same of number of vacuum grippers of each assembly is attached to a surface on which the apparatus is to be moved. As described above, each vacuum gripper has a gripping face, at which the vacuum gripper is configured to be attached to the surface. The gripping faces of all the vacuum grippers which are attached to the surface, at the same moment, together define a surface gripping face of the caterpillar apparatus. It is to be understood herein that each of the vacuum grippers can be any one of the exemplary vacuum grippers 130, 130′, 230, 230′, 330, 330′, 430, 430′, 530, 530′ described above according to various examples of the presently disclosed subject matter, or any other such vacuum gripper.

Each of the caterpillar assemblies can have respective moving systems, as described above or the caterpillar apparatus can have a common moving system comprising components of each of the respective moving systems of the assemblies with additional components for facilitating coordination between those moving systems. The moving system of each of the assemblies, or the common moving system for both the assemblies, i.e., constituting the moving system of the caterpillar apparatus, can be securely mounted to the base of the caterpillar apparatus. Irrespective of the fact as to which of the above described caterpillar assemblies are used in the apparatus, the base of the caterpillar apparatus can be configured so as to securely support the respective moving system of each of the caterpillar assemblies, which in turn is configured to securely support the vacuum grippers. When the assembly comprises a stationary track on which the vacuum units are mounted, the base can be also configured for support the stationary track.

The caterpillar assembly can have a plane of symmetry passing through the base of the caterpillar apparatus, and generally parallel to the longitudinal planes of each of the assemblies, such that the assemblies are positioned on opposite sides of the plane of symmetry. Further, the caterpillar apparatus can have a central plane perpendicular to the plane of symmetry and generally coinciding with, or at least parallel to, the central reference planes of each of the assemblies.

The caterpillar apparatus can comprise a pivoting assembly mounted to the base of the caterpillar apparatus and configured to secure the apparatus to the surface and pivot the caterpillar apparatus, e.g. along the central plane and about an axis perpendicular to the central plane and lying in the plane of symmetry. The pivot assembly can comprise at least one vacuum gripper configured to secure, when operated, the pivoting assembly and thus the apparatus to the surface, at least when the moving system of the apparatus is inoperative. For example, in order to change the direction of movement of the caterpillar apparatus, the vacuum grippers of the pivoting assembly can be operated by a vacuum pump associated thereto, thereby securing the apparatus to the surface via the pivoting assembly, and simultaneously all the vacuum grippers of the caterpillar assemblies can be released from the surface. In this state, the pivoting assembly can rotate the base of the caterpillar apparatus (and its assemblies), thereby changing the direction of movement of the apparatus. Successively, the vacuum grippers of the caterpillar assemblies can be operated to be attached to the surface, followed by release of the vacuum grippers of the pivoting assembly from the surface to allow movement of the caterpillar apparatus along the surface. In addition to the above described purpose of changing the direction of movement, for other purposes, the vacuum grippers of the pivoting assembly can be secured with the surface simultaneously with the vacuum grippers of the caterpillar assemblies to increase the strength of the attachment of the apparatus to the surface that might be required for such other purposes.

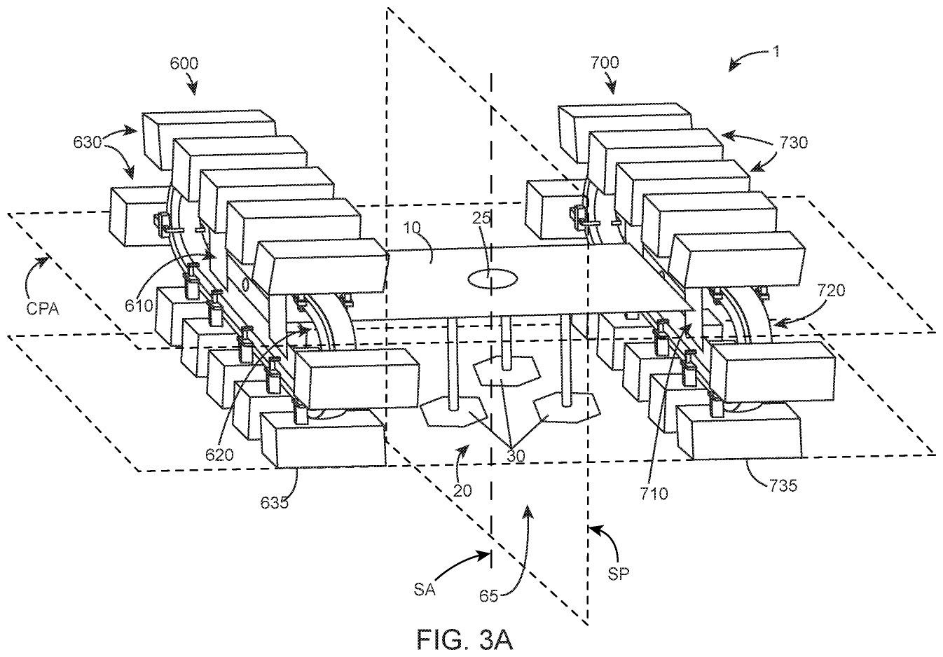

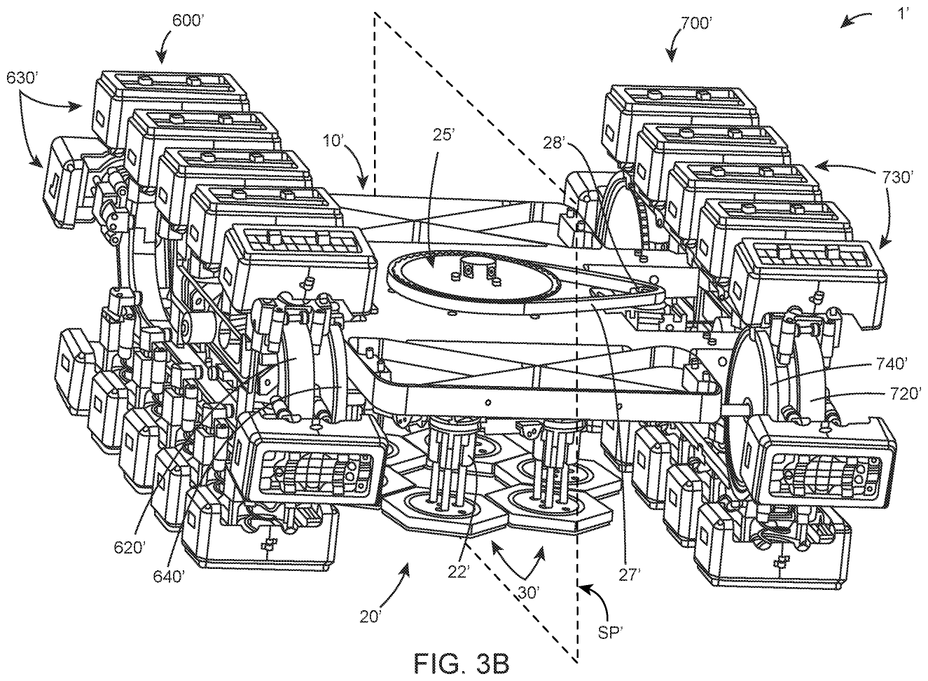

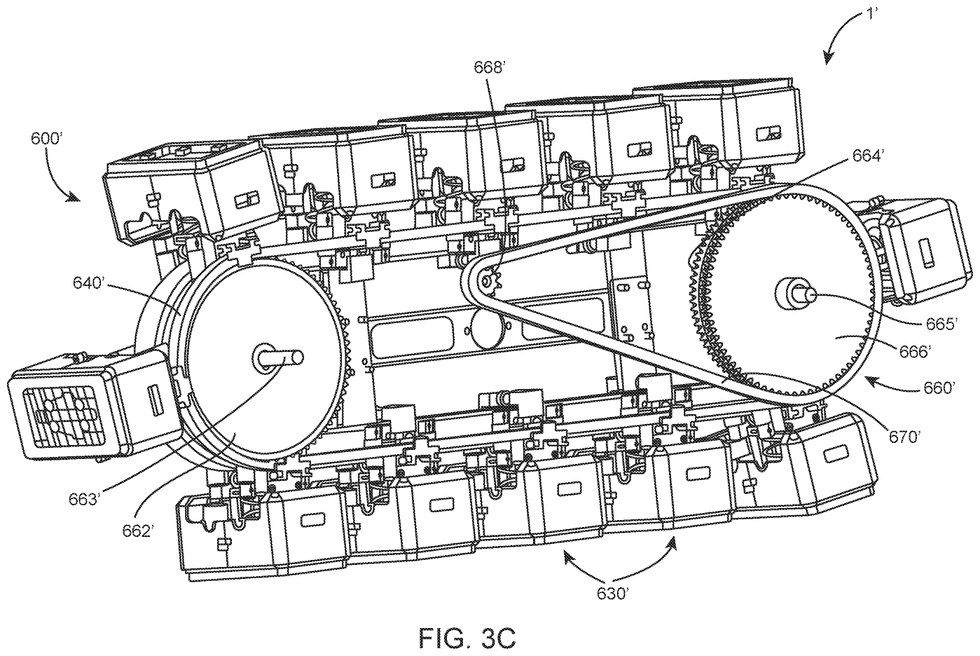

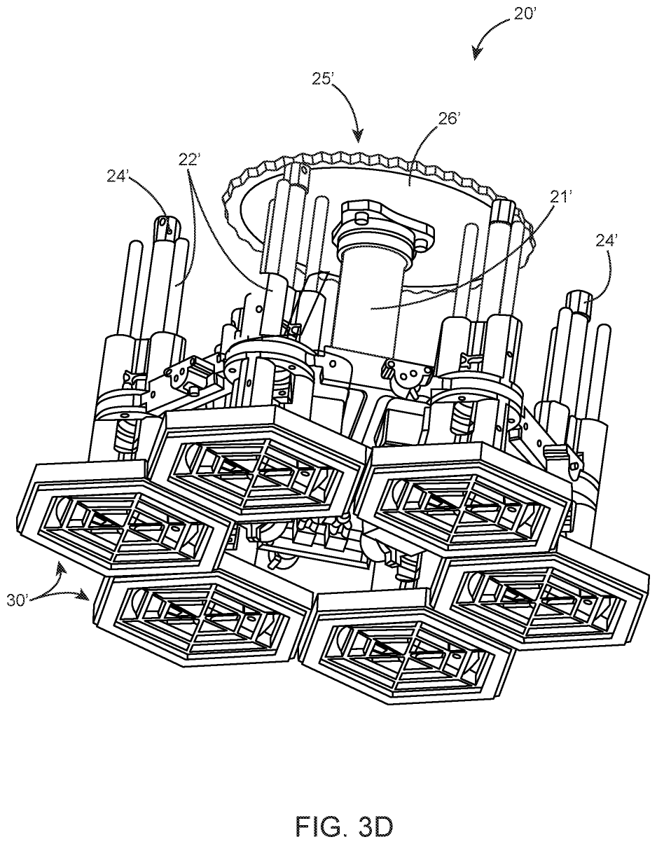

FIG. 3A schematically illustrates a caterpillar apparatus 1 according to an example of the presently disclosed subject matter, comprising two caterpillar assemblies 600 and 700, both similar to the caterpillar assembly 100 schematically illustrated in FIGS. 1A and 1B, according to an example of the presently disclosed subject matter. The description above relating to the caterpillar assembly 100 shown in FIGS. 1A and 1B, and all its components is fully applicable to both of the caterpillar assemblies 600 and 700 shown in FIG. 3A and all their components. Whilst the caterpillar assemblies 600 and 700 have been shown to be similar to the assembly 100 described above with respect to FIGS. 1A and 1B having only one track, which can be stationary or movable, any or both of the caterpillar assemblies 600 and 700 can be either of the exemplary caterpillar assemblies 100′, 200, 200′, 300, 300′, 400, 400′ described above, or any other such assembly.

The caterpillar assemblies 600 and 700 comprise respective tracks 620 and 720, to which the grippers 630 and 730 are connected respectively. The caterpillar assemblies 600 and 700 have respective rigid structures 610 and 710 securely holding the tracks 600 and 700 respectively, and connected to each other via a common base 10, i.e., the base of the caterpillar apparatus 1. It should be noted that base 10 can be structured from several components, e.g., bars, rods, flanges, a like elements and/or any combination thereof, so as to reduce the overall weight of the base.

The caterpillar apparatus 1 has a plane of symmetry SP passing through the base 10 and extending respectively to the longitudinal planes (not shown) of the assemblies 600 and 700. The assemblies 600 and 700 are positioned on the two sides of the plane of symmetry SP of the apparatus 1. The caterpillar apparatus 1 has a central plane CPA extending perpendicular to the plane of symmetry SP. The apparatus 1 further comprises a gripping face 65 parallel to the central plane CPA and constituted by the gripping faces 635 and 735 of those vacuum grippers of the assemblies 600 and 700 which are connected to the surface on which the apparatus 1 is to be moved. For example, at least one vacuum gripper of the assembly 600 and at least one vacuum gripper of the assembly 700 which are connected to the surface on which the apparatus 1 is to be moved, define the gripping face 65.

The base 10 has a pivoting assembly 20 of the apparatus 1, mounted thereto and configured to secure the base 10, and thus the apparatus 1, to the surface and to pivot the caterpillar apparatus 1 along the central plane CPA, and about an axis SA perpendicular to the central plane CPA and lying in the plane of symmetry SP. The pivoting assembly 20 comprises vacuum grippers 30 configured to securely attach the pivoting assembly 20, and consequently the apparatus 1, to the surface. The pivoting assembly 20 further comprises a moving system 25 configured to move the base 10 of the apparatus 1 along the central plane CPA to change the direction of movement of the apparatus 1, at least when none of the vacuum grippers 630 and 730 are attached to the surface, and the vacuum grippers 30 are attached to the surface. The moving system 25 can comprise a gear arrangement, wheel, movable belt, any combination thereof and/or any other mechanism configured to move the base 10 as described above.

FIG. 3B illustrates a caterpillar apparatus 1′ showing more structural details of the caterpillar apparatus according to another example of the presently disclosed subject matter. The apparatus 1′ comprises two caterpillar assemblies 600′ and 700′, both of which are similar to the caterpillar assembly 400′ described above with reference to FIG. 1I, and the description above relating to the caterpillar assembly 400′ shown in FIG. 1I, and all its components is fully applicable to both of the caterpillar assemblies 600′ and 700′ shown in FIG. 3B and all their components.

Similar to that of caterpillar assembly 400′, the caterpillar assembly 600′ comprises a movable track 640′ having vacuum grippers 630′ fixedly mounted therewith, and a stationary track 620′, to which the vacuum grippers 630′ are slidingly connected and supported thereby. Also, the caterpillar assembly 700′, similar to the assembly 400′, comprises a movable track 740′ having vacuum grippers 730′ fixedly mounted therewith, and a stationary track 720′, to which the vacuum grippers 730′ are slidingly connected. The assemblies 600′ and 700′ are connected to each other via a base 10′ of the apparatus 1′, and are positioned on the two sides of a plane of symmetry SP′. The apparatus 1′ is configured to be moved along the surface by the assemblies 600′ and 700′, which are configured to be moved by their respective moving systems, one of which, i.e., a moving system of the assembly 600′, has been shown in an inner view of the caterpillar apparatus 1′ illustrated in FIG. 3C.

FIG. 3C illustrates an inner view of the apparatus 1′ achieved by taking a cross section of the apparatus 1′ along a plane parallel to the plane of symmetry SP′ with some components of the apparatus 1′ not shown for the purposes of clarity in illustration. As can be seen in FIG. 3C, the caterpillar assembly 600′ has a moving system 660′ comprising the movable track 640′. The moving system 660′ has two gears 662′ and 664′ on which the movable track 640′ is configured to move in a counterclockwise or counter clockwise direction with respect to the central axis CA. The two gears 662′ and 664′, each are rotatable about a respective axle 663′ and 665′, which are, according to the illustrated example, common for both the assemblies 600′ and 700′. In addition, the moving system 660′ has another pair of gears 666′ and 668′. The gear 666′ shares the axle 665′ with the gear 664′, such that the rotation of gear 666′ causes the axle 665′ to rotate, which in turn causes the rotation of the gear 664′ and thus that of the movable track 640′. The gear 668′ has a driving mechanism/motor (not shown) associated therewith and configured to rotate the gear 668′. The gears 668′ and 666′ have a belt 670′ configured to rotate thereon and to transfer the rotational movement of the gear 668′ to the gear 666′. In operation, the motor rotates the gear 668′, which is then transferred to the gear 666′ by the belt 670′. The gear 666′ rotates the axle 665′, which causes the gear 664′ to rotate, and consequently, to rotate the movable track 640′ and in turn, the gear 662′. Thus, the moving system 660′ is configured to move the vacuum grippers 630′ (and correspondingly the grippers 730′, because the axles 663′ and 665′ are common for both the assemblies 600′ and 700′) along with the movable track 630′ to cause the apparatus l′ to move in its direction of movement. In some examples, a moving system can comprise only one pair of gears and a driving mechanism/motor to directly rotate those gears. In some examples, a moving system can comprise more than four gears, for example an additional gear between the gears 662′ and 666′ for increased support to the movable track.

The two gears of each assembly can also be configured to provide tension for the movable track, similarly to caterpillar tracks of an armed vehicle.

The moving system 660′ is configured to ensure that at least two vacuum grippers of each assembly are in their respective gripping positions (as described above) at every moment. In some embodiments, the moving system 660′ is configured so as to ensure that at least two vacuum grippers of the caterpillar apparatus are in their respective gripping positions (as described above) at every moment.

Reference is now made again to FIG. 3B illustrating the caterpillar apparatus 1′ which further comprises a pivoting assembly 20′ mounted to the base 10′ of the apparatus 1′. The pivoting assembly 20′ (shown in FIG. 3D) comprises a plurality of vacuum grippers 30′, each configured to be securely attached to the surface when vacuum is created within them. The pivoting assembly 20′ comprises piston arrangements 22′ each associated with one of the vacuum grippers 30′, such that each piston arrangement 22′ has a top end 24′ at a first end configured to abut a proximal section of the base 10′ disposed closer to that surface, e.g., when the vacuum pistons 22′ are retracted, and a gripper 30′ connected at the other end. The pivoting assembly 20′ further comprises a base 21′ configured to support the piston arrangements 22′ at one end thereof and having a moving system 25′ at another end thereof. The moving system 25′ is configured to facilitate the movement of the base 10′, and thus the pivoting of apparatus 1′, along the central plane thereof. The moving system 25′ comprises a gear 26′ connected to the base 21′ and is configured to be rotated about an axis perpendicular the central plane of the apparatus 1′. The gear 26′ is connected to the base 10′ of the apparatus 1′ so as to pivot the base 10′, and thereby the apparatus 1′, therewith. The gear 26′ is rotatable by a belt 27′ (as best seen in FIG. 3B), which in turn is movable by another gear 28′ (as best seen in FIG. 3B) configured to be rotated by a driving mechanism/motor (not shown) associated therewith. In operation, the vacuum grippers 30′ can be attached to the surface, and the apparatus can be pivoted, i.e., rotated by the moving system 25′ about an axis perpendicular to the central plane and lying in the plane of symmetry of the apparatus 1′, at least when the grippers 630′ and 730′ are not attached to the surface.

Using individual grippers for the pivot arrangement allows utilizing a smaller gripping face for gripping onto a surface than in case where a single gripper would have been used. This can be useful for clinging the assembly 100 onto extremely uneven surfaces, which do not have planar areas which are large enough for the entire gripping face of the pivot arrangement.

The piston arrangements 22′ are configured for enabling adjustment of the distance between the base 10′ and the surface on which the apparatus is to be moved. Further, the piston arrangements 22′ are configured for orienting the apparatus 1′ at an adjustable angle with respect to the central plane as well as the plane of symmetry of the apparatus 1′. For the purpose of adjusting the distance between the base 10′ and the surface, all the piston arrangements 22′ can be operated simultaneously and in the same direction to increase or decrease their lengths to an equal extent. For the purpose of orienting the apparatus 1′, the piston arrangements 22′ can be operated independently to change their respective lengths by unequal extents so as to orient the apparatus 1′ with respect to the central plane as well as the plane of symmetry of the apparatus 1′. The distance of the vacuum grippers 630′ and 730′ from the tracks 620′ and 720′, respectively, is also adjusted in coordination with the adjustment of the piston arrangements 22′, for example, by a controller. The adjustment of distance and orientation of the apparatus 1′ facilitates the operation of the apparatus on an uneven surface, such as an inclined surface and/or a surface which comprises elevations, depressions, steps or ditches.

It should be noted that any of the above examples of the caterpillar apparatus or any other such apparatus according to the presently disclosed subject matter, each vacuum gripper of each of the caterpillar assemblies and of the pivoting assembly, is configured so that, in case of a power failure at the time when it is attached to a surface, it maintains this attachment by entering its vacuum mode, thereby ensuring that the caterpillar apparatus is secured to the surface.

In any of the above-described examples of a caterpillar apparatus according to the presently disclosed subject matter, as well as any other such apparatus can comprise a controller configured to control the movement of the vacuum grippers of the assemblies and/or those of the pivoting assembly. The controller can control the moving system, e.g., the rotation rate of the track, the speed of the movable track, the speed of rotation of the gears of the vacuum grippers, the adjusting devices, the piston arrangements, and/or the releasement and securement of the vacuum grippers of the piston assembly. By controlling the speed at which the vacuum grippers are moved, the controller can set the pace at which the caterpillar apparatus advances along the surface. The setting of the advancement rate enables the use of the apparatus for many purposes. For example, cleaning windows of a skyscraper may require the caterpillar apparatus to move relatively slow, e.g., at a rate between 5 to 15 meters per minute, whereas functioning as a rescue device for rescuing people from high story buildings may require the caterpillar apparatus to move much faster, e.g., at a rate between 20 to 40 meters per minute.

Additionally, the controller is configured to ensure that at least two vacuum grippers, including the vacuum grippers of the pivot arrangement, are secured at the required vacuum pressure to the surface at all times. For example, the controller may advance the vacuum grippers which are not secured to the surface faster than the ones that are secured to the surface. This deferential movement of the vacuum grippers, can ensure that more than two vacuum grippers are secured to the surface at all time, thereby increasing the overall safety operation of the apparatus and the advancement rate of the apparatus.

In general, the moving system of a caterpillar assembly according to the presently disclosed subject matter can be any moving system that enables the vacuum grippers to move along the movement direction such as to allow bringing the grippers successively into their gripping position while making sure that there are always at least two vacuum grippers that are in such position, and the grippers can be connected to the moving system in any suitable manner, e.g., in a detachable manner, thereby enabling the replacement of each gripper if and/or when required.

The moving system does not necessarily have to comprise a movable track, rather, the moving system can be of a human legs kind, e.g., i.e. with two or four legs having adjustable distance and angles with respect to the central reference plane.

In case the moving system does comprise a movable track, e.g., an endless movable track, it can be in the form of a continuous conveyer-like strap of the kind described above or in the form of a plurality of discrete track elements pivotally connected to each other by pivot axles, each track element being associated with a vacuum gripper. In the latter case, the moving system can further comprise any means operable to move the track elements and/or the pivot axles, to successively bring the vacuum grippers into gripping position. For example, the moving system can comprise at least one gear rotatably mounted to a stationary element of the caterpillar assembly, and configured to be rotated by a driving mechanism/motor (not shown) associated therewith, the at least one gear securely engaging the track elements and/or the pivot axles so as to move them upon rotation of the at least one gear.

When the movable track comprises the above track elements, vacuum grippers can be detachably attachable thereto, or integrally mounted thereto or unitarily formed therewith. In a specific example, the vacuum gripper can have a central axis and comprise a gripping portion with a gripping face oriented perpendicular to the central axis of the gripper and a mounting portion spaced from the gripping face along the central axis of the gripper and comprising an attachment extension oriented transversely to the central axis and having two attachment ends on two sides of the central axis, the attachment ends being each pivotally connectable to a pivot axle, enabling the attachment extension to constitute the track element of the movable track when the caterpillar assembly is assembled. Optionally, the attachment extension can have two attachment extension portions extending in opposite directions from the central axis of the gripper, each having a proximal end adjacent the central axis and a distal end spaced from the central axis and pivotally connectable to a pivot axle. The mounting portion can further comprise at least one attachment element extending between the gripping portion and the attachment extension. The mounting portion can comprise two attachment elements, which can generally extend along the central axis of the gripper on two sides thereof, each connected to the proximal end of one the attachment extension portions. The two attachment elements can be disposed close to each other or rather can be spaced from each in a direction perpendicular to the central axis of the gripper.

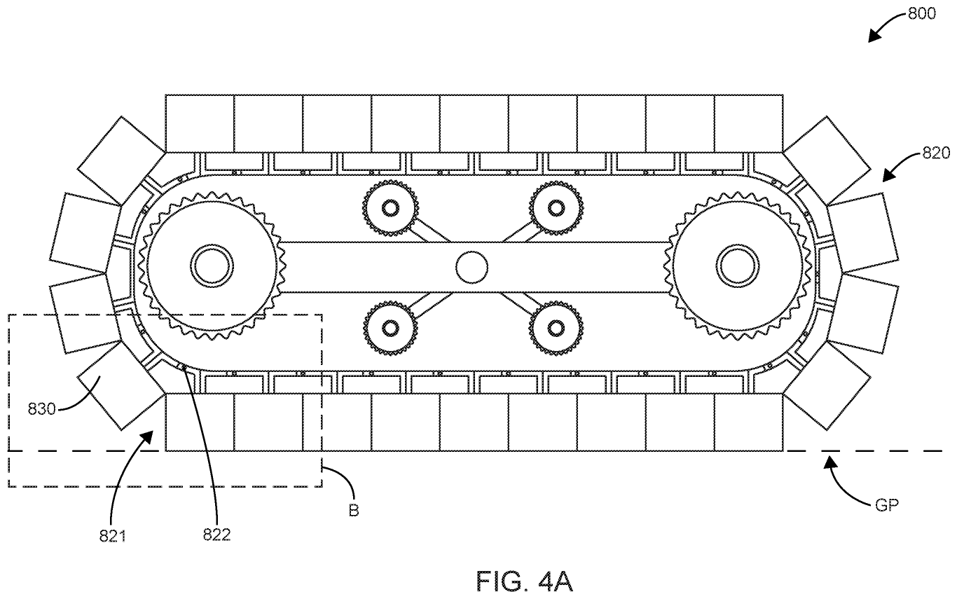

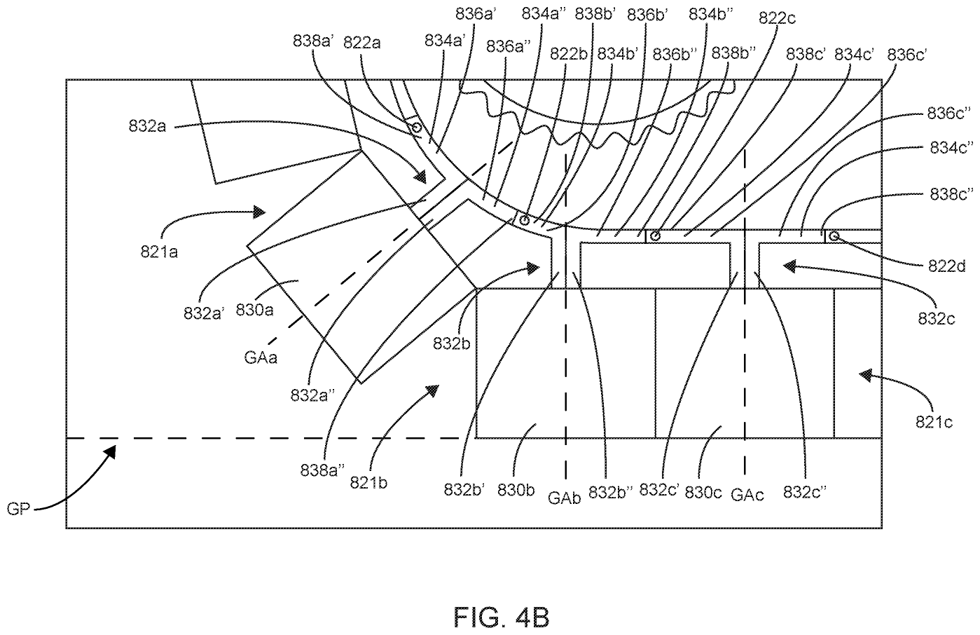

FIG. 4A schematically illustrates a caterpillar assembly 800 according to another example of the presently disclosed subject matter, which can function as a single-line caterpillar apparatus, or can constitute a part of a two-line or multiple-line apparatus having two or more such assemblies, respectively. Endless movable track 820 along with vacuum grippers 830, can be used in the caterpillar assembly 800 of the present example in a manner similar to that described above with respect to movable tracks of the previous examples.

The track 820 comprises a succession of discrete track elements 821 pivotally connected to each other by pivot axles 822, each track element being associated with one of the vacuum grippers 830.

Components of the assembly 800 other than the track elements and axles of the movable track 820 and components of each vacuum gripper 830 other than its mounting portion, and their operation, can be the same as those described above with respect to the assemblies and vacuum grippers of the previous examples.

All the track elements and the associated portions of all the vacuum grippers 830 are identical, and they will now be described in more detail with reference to FIG. 4B, which illustrates a portion ‘B’ of the track 820 shown in FIG. 4A. The track 820 can thus be considered as comprising a plurality of such portions and the description below is applicable to each of them.

In FIG. 4B, three adjacent vacuum grippers designated as 830a, 830b and 830c are shown, each having a central axis GAa, GAb and GAc, and a mounting portion 832a, 832b and 832c, respectively. The grippers are shown at the moment when the gripper 830a is just about to reach its starting position before it enters its suction mode, and the grippers 830b and 830c have reached their starting position, with gripper 830b being in its suction mode and gripper 830c in its vacuum mode.

The mounting portion 832a of the vacuum gripper 830a comprises two attachment elements 832a′, 832a″ unitarily formed with respective attachment extension portions 834a′ and 834a″ extending on two sides of the central axis GAa perpendicularly thereto. Each attachment extension portion 834a′, 834a″ has a proximal end 836a′, 836a″ and a distal end 838a′, 838a″, respectively, the distal ends being pivotable about respective pivot axles 822a and 822b.

Similarly, the mounting portion 832b of the vacuum gripper 830b comprises two attachment elements 832b′, 832b″ unitarily formed with respective attachment extension portions 834b′ and 834b″ extending on two sides of the central axis GAb perpendicularly thereto. Each attachment extension portion 834b′, 834b″ has a proximal end 836b′, 836b″ and a distal end 838b′, 838b″, respectively, the distal ends being pivotable about respective pivot axles 822b and 822c.

Similarly, the mounting portion 832c of the vacuum gripper 830c comprises two attachment elements 832c′, 832c″ unitarily formed with respective attachment extension portions 834c′ and 834c″ extending on two sides of the central axis GAc perpendicularly thereto. Each attachment extension portion 834c′, 834c″ has a proximal end 836c′, 836c″ and a distal end 838c′, 838c″, respectively, the distal ends being pivotable about respective pivot axles 822c and 822d.

The attachment elements with their attachment extension portions of the mounting portion of each of the grippers 830a, 830b and 830c constitute one of the discrete track elements 821 of the movable track 820 shown in FIG. 4A. These elements are thus designated in FIG. 4B as 821a, 821b and 821c, respectively.

As clear from FIG. 4B, the pivotal connection of the track elements 821 to the pivot axles 822 enables the grippers to take their orientation at an adjustable angle with respect to the central reference plane and/or the surface gripping face and grip plane GP. For example, during the movement of the track the track elements 821 can be moved from one side to the other side of the central referee plane, thereby being oriented parallel to the grip plane GP, at angle thereto, perpendicular thereto and so on and so forth.

Similarly to vacuum grippers described above with reference to FIGS. 2A to 2C, vacuum grippers 830 can each comprise an adjusting device configured for enabling adjustment of the distance between the gripping face or gripping portion of the vacuum gripper, and the attachment extensions along the gripper central axis, and/or orientation thereof at an adjustable angle with respect thereto. Such adjustment/s can enable the caterpillar apparatus to advance over an uneven surface, such as an inclined surface and/or a surface which comprises elevations, depressions, steps or ditches.

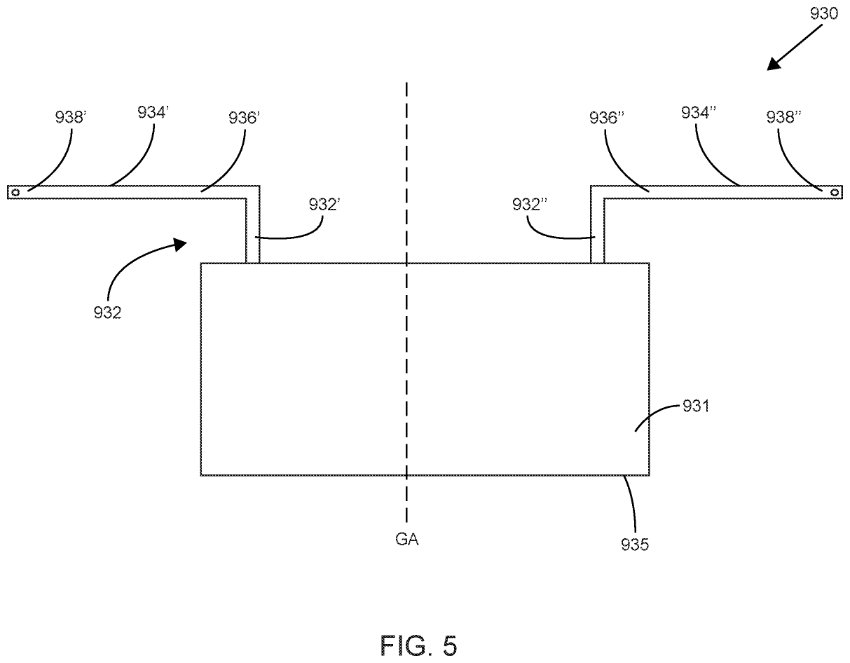

FIG. 5 schematically illustrates a vacuum gripper unit 930, which can be used in the caterpillar assembly 800 or any other caterpillar assembly according to the presently disclosed subject matter. The vacuum gripper unit 930 differs from the vacuum grippers shown in FIGS. 4A and 4B in that its attachment elements are spaced from each other in a direction perpendicular to the central axis GA of the gripper unit.

Thus, the gripper unit 930 comprises a gripping portion 931 with a gripping face 935 oriented perpendicular to the central axis GA of the gripper and attachable, when vacuum is applied to the gripping unit, to a surface on which the caterpillar assembly is to be moved. The gripper unit 930 further comprises a mounting portion 932 disposed opposite to the gripper unit and spaced from the gripping face along the axis GA. The mounting portion 932 comprises two attachment elements 932′ and 932″ unitarily formed with respective attachment extension portions 934′ and 934″ extending on two sides of the central axis GA perpendicularly thereto. Each attachment extension portion 934′, 934″ has a proximal end 936′, 936″ and a distal end 938′, 938″, respectively, the distal ends being configured for pivoting connection to a pivot axle.

The pivoting connection of the distal ends of the attachment extensions of vacuum gripper units described above with reference to FIGS. 4A, 4B and 5, can be provided by any suitable means. For example, the distal ends of the attachment extension portions can be formed with through holes configured to freely receive therein the corresponding pivot axles.

Although not illustrated in FIGS. 4A to 5, the attachment elements can be a part of and/or provided with an adjusting device similar to the adjusting device described hereinabove with respect to FIGS. 2A, 2B and 2C. Discrete element 938a″ can be configured for adjustably attaching to discrete element 938b′ of a front vacuum gripper, whereas discrete element 938b″ can be configured for adjustably attaching to discrete element 938c′ of a rear vacuum gripper (similar to that illustrated in FIGS. 4A and 4B with respect to discrete elements 838′ and 838″).

The movable caterpillar assemblies described above with reference to FIGS. 1A to 5, are selectively attachable to a non-horizontal advancement surface such as an exterior surface of a building, and particularly to a window thereof, and are moveable therealong. The movable assemblies have a track and a plurality of gripper units being movable along the track. The movable assembly detailed below can be similar in operation to any one of the above detailed movable assemblies, at least in the manner of operation and usage. The moveable assembly has a moving system which can be the same as any of the moving systems described according to the various examples above.

The movable assembly has a track, which according to the illustrated example, is a stationary track, constituting a structural member of the movable assembly, having an upward facing sliding surface, a downward facing sliding surface, and at least one sideward facing sliding surface. For the purposes of understanding throughout this application, the downward facing sliding surface is the surface of the track that faces the non-horizontal advancement surface during operation of the movable assembly, e.g., the wall, the upward facing sliding surface is the surface of the track facing opposite the downward facing sliding surface, e.g., away from the wall, and the sideward facing sliding surface extends laterally, optionally between the upward facing sliding surface and the downward facing sliding surface.

The movable assembly further has a plurality of gripper units by virtue of which the movable assembly is configured to be selectively attached to the non-horizontal advancement surface. Each of the gripper units can be similar in operation to any of the above detailed gripper units. For instance, the gripper unit can be configured to be selectively attachable to the advancement surface by virtue of vacuum. As in the previous examples, the currently discussed gripper unit has a gripping portion configured to be selectively attached to the advancement surface, and a mounting portion configured to be slidingly mounted to the track. In particular, the gripping portion has a gripping face that are selectively fixable to the advancement surface, and the slidable mounting of the mounting portion to the track enables the track to move with respect to the gripping unit, when the gripping face thereof are fixed to the wall, during advancement of the movable assembly. The gripping face defines a gripping plane, coinciding with the advancement surface when the gripping portion is fixed thereto. The movable assembly has a longitudinal axis extending along the track, e.g., extending in the direction along which the movable assembly advances on the advancement surface, and a lateral axis perpendicular to the longitudinal axis, extending across the movable assembly. The longitudinal, as well as the lateral axis, are defined such that they are parallel to the gripping plane, when the gripping face are fixed to the advancement surface. In general, the mounting portion is configured to be slidingly mounted to the track to enable the movable assembly to move along the advancement surface in the manner as described above in any of the above examples.

The mounting portion has an upper sliding arrangement configured for slidingly engaging the upward facing sliding surface of the track and to thereby support the movable assembly when the longitudinal and/or the lateral axis is/are oriented in an acute angle with respect to the horizon, i.e., when the movable assembly climbs a downward facing slope, such as a window angled towards the ground, or a sloped/non sloped ceiling. The mounting portion further has a lower sliding arrangement configured for slidingly engaging said downward facing surface of said track, and thereby support said movable assembly when at least one of said axes is oriented in an obtuse angle with respect to the horizon, i.e., when the movable assembly climbs an upward facing slope, e.g., a hill or a downhill, such as a sloped/non sloped window or wall facing away from the ground. The mounting portion further has at least one side sliding arrangement configured for slidingly engaging said sidewards facing surface, so as to support said movable assembly when said lateral axis is oriented in an angle with respect to the horizon, i.e., when the movable assembly is advances along a side slope, with one side thereof facing the ground and another facing away therefrom.

For the purposes of the understanding of this application, the horizon is to be understood as the imaginary horizontal line where the earth and the sky appear to meet. Further, for the purposes of this application, the horizon is to be understood as being in the same vertical plane as that of the longitudinal or the lateral axis when an angle between any one of the them and the horizon is referred to. For instance, for the understanding of the angles between the horizon and the longitudinal axis, the horizon is to be understood either as being in the same vertical plane as that of the longitudinal axis, or as an imaginary horizontal line lying in that plane and parallel to the actual horizon. For the understanding of the angles between the horizon and the lateral axis, the horizon is to be understood either as being in the same vertical plane as that of the lateral axis, or as an imaginary horizontal line lying in that plane and parallel to the actual horizon.

For the purposes of the understanding of this application, the angles, whether acute or obtuse, are to be understood as being seen from the direction opposite to the advancement surface, i.e., not including the advancement surface therewithin. For instance, the angle between any of the two axes and the horizon is to be considered such the advancement surface does not lie between the respective axis and the horizon. In other words, the angles are to considered as being viewed from a point positioned with respect to the axis in a direction opposite to that of the advancement surface from the axis.

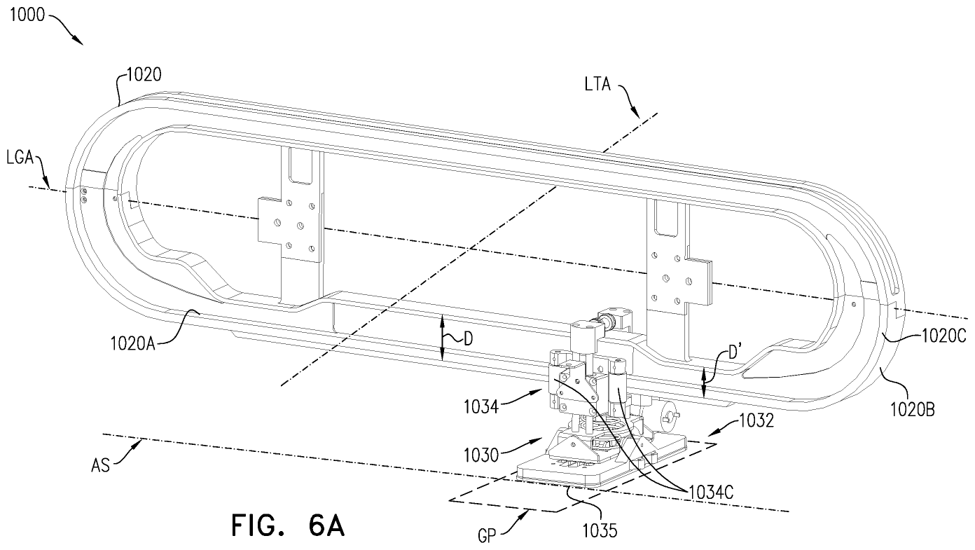

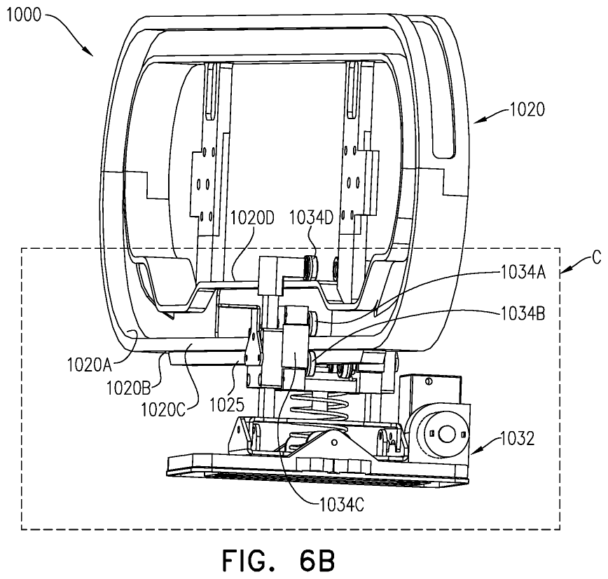

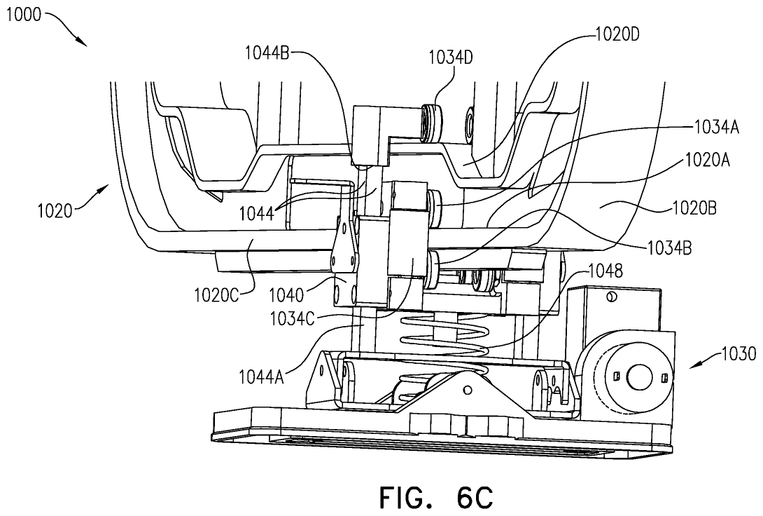

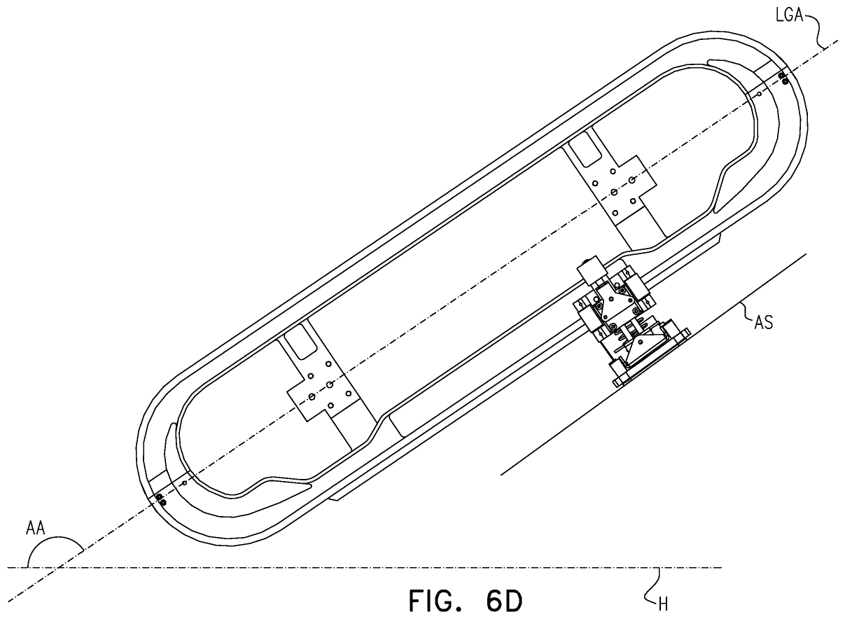

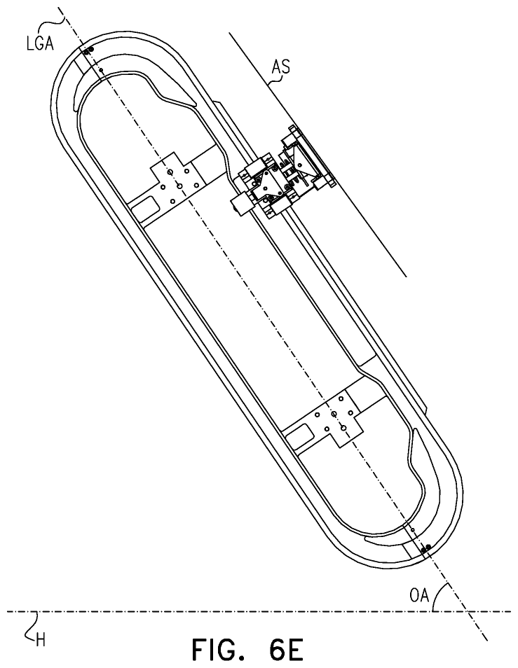

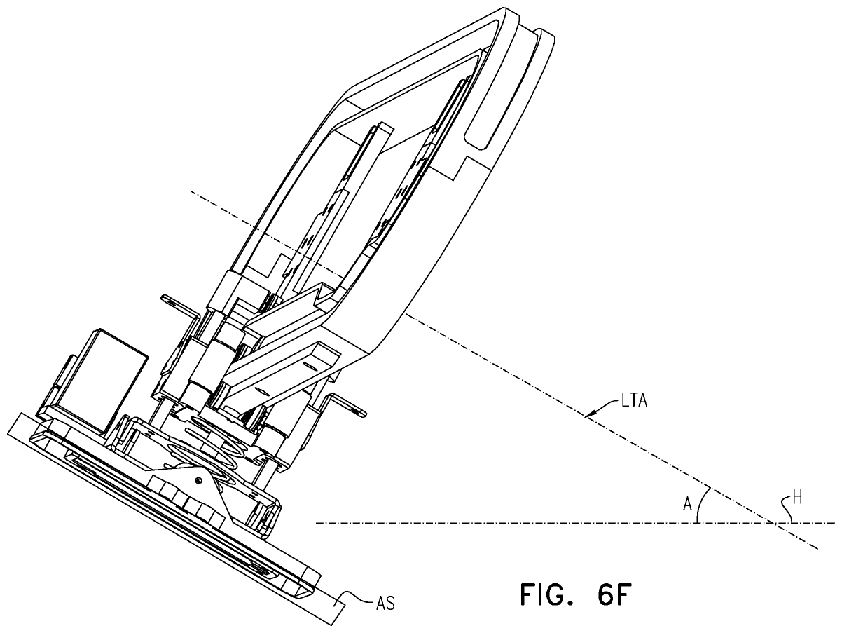

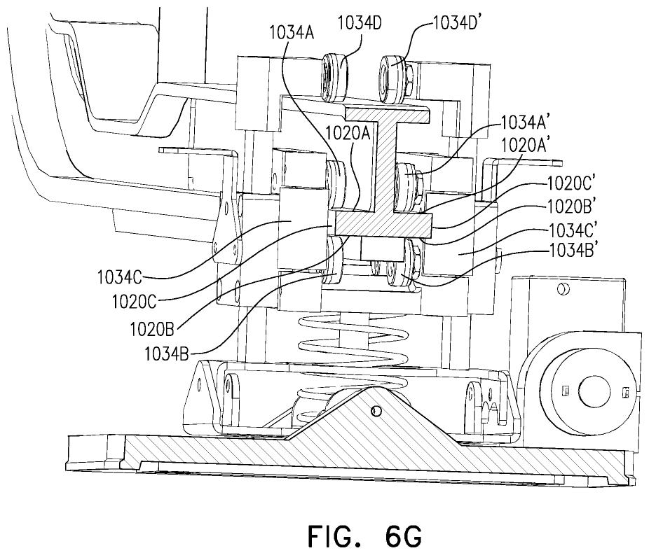

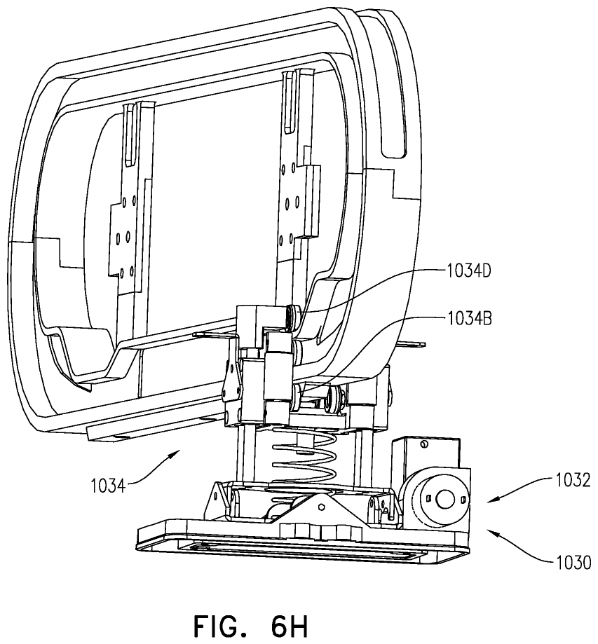

FIGS. 6A-6H illustrate such a movable assembly generally designated as 1000 having the track 1020 and the gripper unit 1030. Although the movable assembly 1000 has a plurality of gripper units, in a manner similar to the movable caterpillar assemblies detailed above, only one gripper unit has been illustrated here for the purposes of simplicity. The movable assembly 1000 can constitute a part of the caterpillar apparatus, similarly as detailed above, comprised of two such movable assemblies, and can have a moving system similar in operation to that of any one of the moving systems detailed above. For that reason, and for the purposes of conciseness of the application the moving system of the assembly 1000 is not been shown in FIGS. 6A-6H.

The movable assembly 1000 is configured to move along a non-horizontal advancement surface, generally designated as AS. The upward facing sliding surface of the track 1020 has been designated as 1020A, the downward facing sliding surface has been designated as 1020B, and the sideward facing sliding surface has been designated as 1020C. It should be appreciated that in the present example, all surfaces are circular, and as such, extend circularly along the entire track 1020. The longitudinal axis and the lateral axis of the movable assembly 1000 have been designated as LGA and LTA respectively.

The gripper unit 1030 has the gripping portion, designated as 1032, and the mounting portion, designated as 1034. The gripping portion 1032 has a gripping face 1035 configured to be selectively fixable to the advancement surface AS, and defining the gripping plane GP, which coincide with the advancement surface AS when the gripping face 1035 are fixed to the advancement surface AS. The longitudinal and lateral axes LGA, LTA, are defined such that in the position of the gripping face when it is fixed to the advancement surface AS, the gripping plane GP is parallel to the longitudinal and lateral axis LGA and LTA of the movable assembly 1000.

The mounting portion 1034 is slidingly mounted to the track 1020 at its sliding surfaces 1020A, 1020B, and 1020C. As described in detail above with respect to the examples of the moving systems, the mounting portion 1034 enables the track 1020 and the gripper unit 1030 to slide along and with respect to each other. As can be best seen in FIG. 6C, the mounting portion has an upper sliding arrangement 1034A configured for slidingly engaging the upward facing sliding surface 1020A of the track 1020, a lower sliding arrangement 1034B configured for slidingly engaging the downward facing sliding surface 1020B of the track 1020, and a side sliding arrangement 1034C configured for slidingly engaging the sideward facing sliding surface. In the illustrated example, the sliding arrangements are rollers configured to roll with respect to the track 1020. In other examples, the sliding arrangements can be achieved as a different structure such as simply smooth surfaces sling on each other, ball arrangements, magnetically activated surfaces, etc.

When the movable assembly 1000 is moving on the advancement surface AS being inclined such that the longitudinal axis LGA and/or the lateral axis LTA of the movable assembly 1000 is oriented in an acute angle with respect to the horizon, the upper sliding arrangement 1034A slidingly supports the assembly 100, via supportive engagement with the upward facing sliding surface 1020A thereof. FIG. 6D illustrates the movable assembly 1000 in an orientation where the longitudinal axis LGA is oriented in an acute angle AA with respect to the horizon H. In this orientation of the movable assembly 1000, the upward facing sliding surface 1020A is supported by the upper sliding arrangement 1034A and can slidingly move therealong when the track 1020 is advanced by the moving system (not shown) with the gripper unit 1030 being attached, i.e., fixed, to the advancement surface AS.

When the movable assembly 1000 is moving on the advancement surface AS being inclined such that the longitudinal axis LGA and/or the lateral axis LTA of the movable assembly 1000 is oriented in an obtuse angle with respect to the horizon, the lower sliding arrangement 1034B slidingly supports the assembly 1000, via supportive engagement with the downward facing sliding surface 1020B thereof. FIG. 6E illustrates the movable assembly 1000 in an orientation where the longitudinal axis LGA is oriented in an obtuse angle OA with respect to the horizon H. In this orientation of the movable assembly 1000, the downward facing sliding surface 1020B is supported by the lower sliding arrangement 1034B and can slidingly move therealong when the track 1020 is advanced by the moving system (not shown) with the gripper unit 1030 being attached to the advancement surface AS.

When the movable assembly 1000 is moving on the advancement surface AS, when the latter is inclined, the lateral axis LTA of the movable assembly 1000 is oriented in an angle with respect to the horizon. In such position, the side sliding arrangement 1034C slidingly supports the assembly 1000, via supportive engagement with the sideward facing sliding surface 1020C. FIG. 6F illustrates the movable assembly 1000 in an orientation where the lateral axis LTA is oriented at an angle A with respect to the horizon H. It is to be understood herein that movable assembly 1000 can constitute a part of a caterpillar apparatus having two such assemblies and each having such side sliding arrangement to support the respective sideward facing sliding surface depending on the inclination of the movable assembly. In some examples, the side sliding arrangement can be positioned in the center of width of the track and can be configured to support the movable assembly in two directions when the lateral axis is inclined with respect to the horizon. In the illustrated example, the side sliding arrangement 1034C is disposed laterally between the upper and the lower sliding arrangements 1034A and 1034B.

Although the movable assembly can have only one upper, one lower and one side sliding arrangement, the illustrated example illustrates a pair for each of them. For instance, as can be best seen in FIG. 6G, the track 1020 has another sideward facing surface 1020C′, and the mounting portion 1034 has a corresponding another side sliding arrangement 1034C′. Thus, the mounting portion 1034 has two side sliding arrangements 1034C and 1034C′ disposed on two sides of the track 1020 and configured to slidingly engage the two sideward facing sliding surfaces 1020C and 1020C′ of the track 1020, respectively. Further, the track 1020 has another upward facing sliding surface 1020A′, and the mounting portion 1034 has a corresponding another upper sliding arrangement 1034A′. Thus, the mounting portion 1034 has two upper sliding arrangements 1034A and 1034A′ configured to be disposed on two sides of the track 1020 to slidingly engage the two upward facing sliding surfaces 1020A and 1020A′ respectively. Furthermore, the track 1020 has another downward facing sliding surface 1020B′, and the mounting portion 1034 has a corresponding another lower sliding arrangement 1034B′. Thus, the mounting portion 1034 has two lower sliding arrangements 1034B and 1034B′ configured to be disposed on two sides of the track 1020 to slidingly engage the two downward facing sliding surfaces 1020B and 1020B′ respectively.

Such arrangement is configured to provide stability for the track 1020, as the latter is supported by the sliding arrangements of the gripper unit, and configured to provide load balance between the sliding arrangements, to each on each of which's design.

Further, each sliding arrangement includes a plurality of rollers, namely two rollers, disposed successively on their respective surface. Such arrangement further contributes to the stability of the track 1020, and the load balance between the rollers, as mentioned above.

It should be appreciated that an arrangement of more than two successively arranged rollers, can also be applied under certain conditions, e.g., when the track doesn't include sharp corners.

In the illustrated example, the two downward facing sliding surfaces are two portions of a single continuous surface, divided by a position indicator 1025, which is same in structure and operation as the position indicator as detailed herein above. In some examples, the upward facing sliding surfaces can also be portions of a single surface of the track and/or the downward facing sliding surfaces can be separate surfaces.

The mounting portion 1034 has a support structure 1040, and the upper and the lower sliding arrangements 1034A and 1034B are disposed on the support structure 1040. The side sliding arrangement 1034C is also disposed on the support structure 1040 holding each and every sliding arrangement 1034A, 1034B, and 1034C, to provide enough structural integrity for the sliding arrangements to support the movable assembly. The sliding arrangements are fixedly disposed on the support structure 1040. In the illustrated example, the sliding arrangements are rollers and are configured to roll on the respective surface of the track 1020 while being fixedly disposed on the support structure 1040.

The mounting portion 1034 further includes support elements 1044, which in some examples can be a single support element. The support elements 1044 are connected at a first end 1044A thereof to the griping portion 1032, and are mounted to the support structure 1040 to enable transmission of load forces from the sliding arrangements, especially from the side sliding arrangements 1034C, to the gripping portion 1032. This transmission of forces enable the gripper units, when attached to the advancement surface AS, to support the movable assembly 1000. The support elements 1044 can also slide with respect to the support structure 1040 along with the gripping portion 1032, such that the gripping portion 1032 is movable with respect to the support structure 1040, in a direction perpendicular to a sliding path for the lower sliding arrangement 1034B and thus for the gripper unit 1030 along the track 1020, defined by the downward facing sliding surface 1020B. In fact, the gripping portion 1032 is configured to move closer to and farther from the support structure, i.e., from the downward facing sliding surface.

The mounting portion 1034 further includes an auxiliary sliding arrangement 1034D, which in the illustrated example includes two such arrangements 1034D and 1034D′. In other examples, there can be a single auxiliary sliding arrangement 1034D. The track 1020 has an auxiliary sliding surface 1020D spaced to a varying distance from the downward facing sliding surface 1020B. For instance, as shown in FIG. 6G, the distance between the auxiliary sliding surface 1020D and the downward facing sliding surface 1020B is D at a first location along the track 1020 and D′, smaller than D, at a second location along the track 1020. The auxiliary sliding arrangement 1034D slides along the auxiliary sliding surface 1020B, and thus moves with respect to the lower sliding arrangement 1034B by virtue of the varying distance between the auxiliary sliding surface 1020D and the downward facing sliding surface 1020B. The auxiliary sliding arrangement 1034D is connected to a second end 1044B of the support element 1044 and thus moves the gripping portion 1032 therealong with respect to the downward facing sliding surface 1034B as the auxiliary sliding arrangement 1034D slides along the auxiliary sliding surface 1020D, i.e., when the gripper unit 1030 and the track 1020 slidingly move with respect to each other. For instance, FIG. 6H illustrates that when the distance between the auxiliary sliding surface 1020D and the downward facing sliding surface 1020B decreases, the gripping portion 1032 moves farther from the downward facing sliding surface 1020B. The disposition of the gripping portion 1032 to a maximal distance from the lower sliding arrangement is induced by a biasing member of the gripper unit.

The gripper unit has a biasing member 1048 disposed between the gripping portion 1032 and the lower sliding arrangement 1034B, and configured to the bias the gripping portion 1032 away from the lower sliding arrangement 1034B. The auxiliary sliding arrangement 1034D being connected to the gripping portion 1032, via the support element 1044, is urged by the biasing member 1048 to be in tight engagement with the auxiliary sliding surface 1020D. Thus, the relative sliding movement of the gripper unit 1030 and the track 1020, and the tight engagement between the auxiliary sliding arrangement 1034D with the auxiliary sliding surface 1020D causes the auxiliary sliding arrangement 1034D to follow a curvature of the auxiliary sliding surface 1020B, and consequently causing the gripping portion 1032 to move with respect to the mounting portion 1034 according to the curvature of the auxiliary sliding surface 1020B.

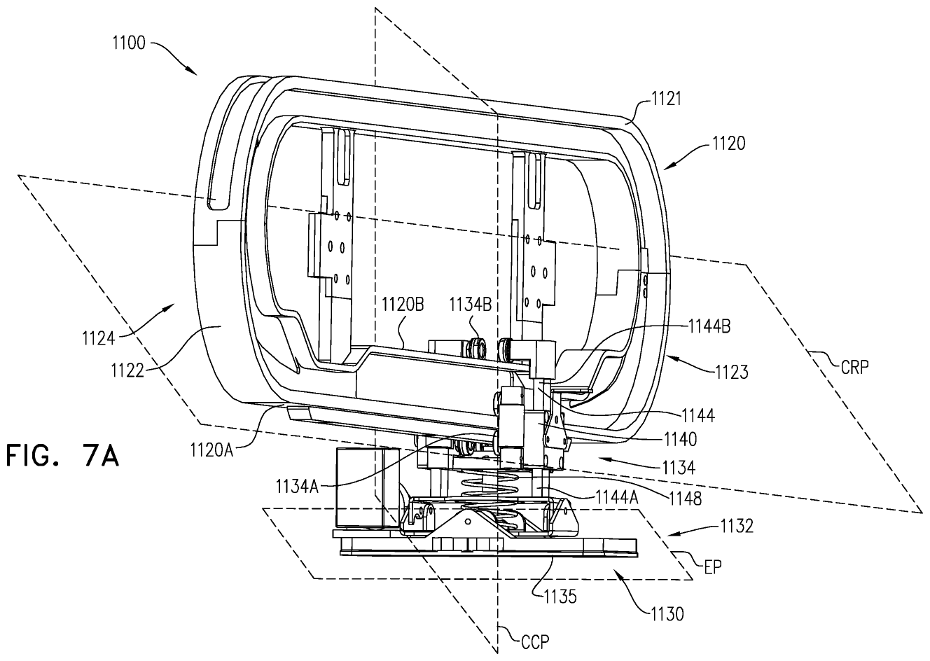

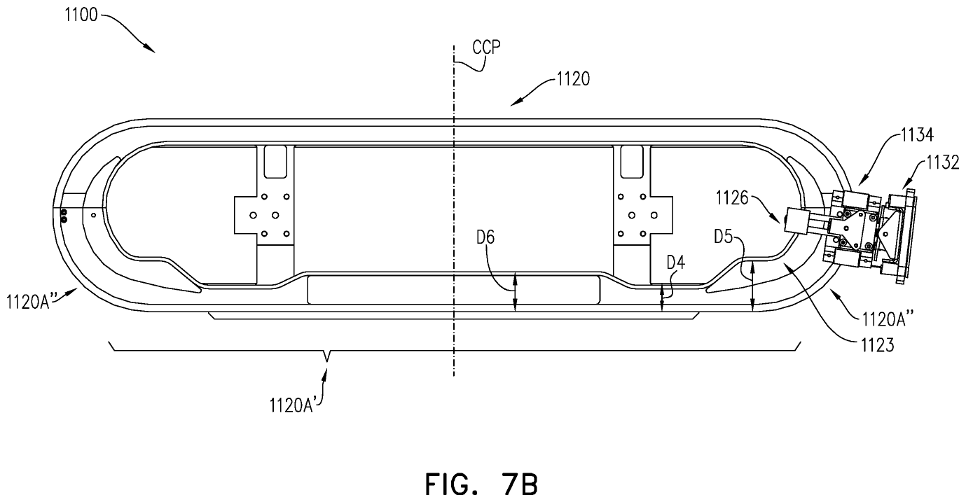

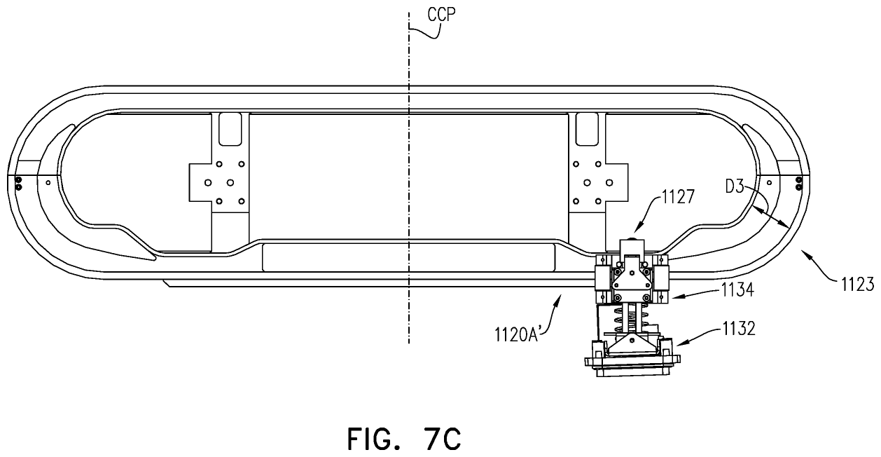

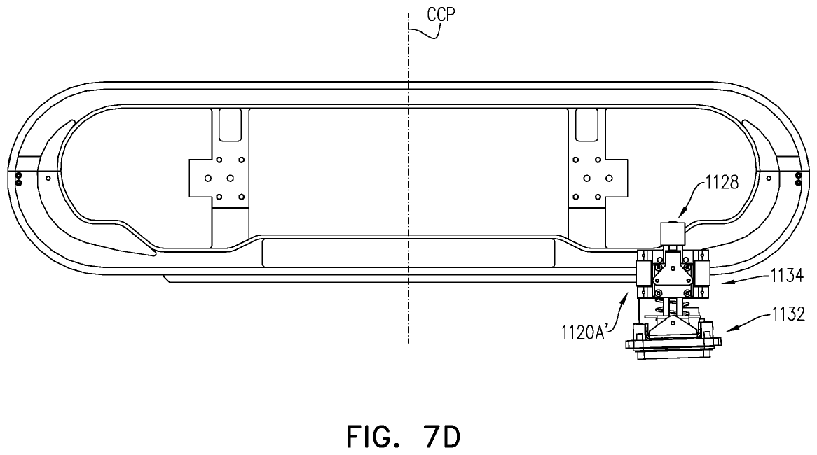

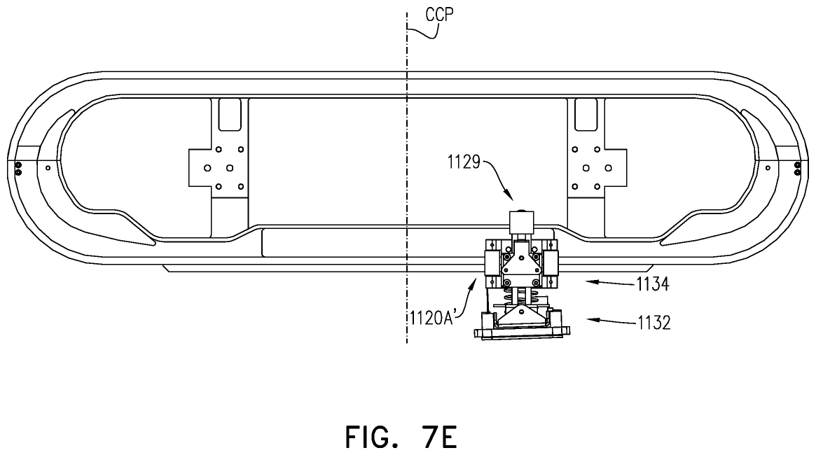

FIGS. 7A-7E illustrate a caterpillar assembly 1100, according to an example of the presently disclosed subject matter. The caterpillar assembly is configured to move on a non-horizontal advancement surface, and comprises a track having a first sliding surface and a second sliding surface spaced from the first sliding surface to a distance varying along a length of the track. The non-horizontal advancement surface can be an exterior surface of a building, a window thereof, or the like. The caterpillar assembly further has a plurality of units slidably mounted to the track and configured to move therealong to facilitate advancement of said caterpillar assembly on the advancement surface. Each of the units has a mounting portion comprising a first sliding arrangement in sliding engagement with the first sliding surface and a second sliding arrangement in sliding engagement with the second sliding surface. The units further include an engaging portion configured to engage the advancement surface. The engaging surface is operatively connected to the second sliding arrangement and is movable with respect to the mounting portion as its respective unit moves along the track, in response to the variation in the distance between the first and second sliding surfaces.

Although, in the illustrated example, the caterpillar assembly, the track, and the unit have been illustrated as being same as the movable assembly 1000, the track 1020, and the gripper unit 1030, respectively, and can operate in the same manner, it is to be understood herein that the caterpillar assembly, the track, and the unit can be realized in a different manner and with different structure to operate in the manner as detailed below.

As can be seen in FIGS. 7A-7E, the caterpillar assembly has been designated as 1100, the track and the unit have been designated as 1120 and 1130 respectively. The first sliding surface of the track 1120, designated as 1120A, is the same as the downward facing sliding surface 1020B of the track 1020, and the second sliding surface of the track 1120, designated as 1120B, is the same as the auxiliary sliding surface 1020D of the track 1020. In other examples, the upward or sideward facing sliding surfaces can serve as the first sliding surface instead of or in addition to the downward facing sliding surface.

The track 1120 has a central reference plane CRP dividing the track 1120 into an upper portion 1121 and a lower portion 1122. For the purposes of understanding this application, the lower portion of the track is the portion which is proximal to the advancement surface during operation of the caterpillar assembly, and the upper portion is the portion that is distal from the advancement surface during operation. The track 1120 has a central crossing plane CCP perpendicular to the central reference plane CRP, and symmetrically dividing the track 1120 in two portions along the length of the track 1120, i.e., rear and frontal. In other examples of the presently disclosed subject matter, the track can be non-symmetrical with respect to any of the planed CCP and CRP. The track 1120 crosses the central reference plane CRP at two flipping areas 1123 and 1124, where each unit 1130 crosses the plane CRP from the lower portion 1122 to the upper portion 1121 of the track, and vice versa, during movement of the unit 1130 along the track 1120.

The engaging portion and mounting portions of the unit 1130 have been designated as 1132 and 1134 respectively. The engaging portion 1132 has an engaging face 1135 that are engageable with the advancement surface (not shown) during operation of the caterpillar assembly 1100, and defines an engaging plane EP coinciding with the advancement surface during engagement therewith. The engaging plane EP is generally parallel to the central reference plane CRP of the track 1120 during said engagement.

The mounting portion 1134 has the first sliding arrangement, designated as 1134A, which in the illustrated example is the same as the lower sliding arrangement 1034B of the movable assembly 1000, and the second sliding arrangement, designated as 1134B, which in the illustrated example is same as the auxiliary sliding arrangement 1034D of the movable assembly 1000. In some examples, the upper or the side sliding arrangements can also serve as the first sliding arrangement 1134A. The first sliding arrangement 1134A is shown in sliding engagement with the first sliding surface 1120A and is configured to move therealong. Similarly, the second sliding arrangement 1134B is shown in sliding engagement with the second sliding surface 1120B and is configured to move therealong. The engaging portion 1132 is operatively connected to the second sliding arrangement 1134B, optionally as described with respect to the gripping portion of assembly 1000, and as the second sliding arrangement moves along the second sliding surface 1120B, the engaging portion 1132 moves with respect to the mounting portion 1134 in response to the variation in distance between the first and the second sliding surfaces 1120A and 1120B along the length of the track.

As can be seen in FIG. 7A-7E, the distance between the first sliding surface 1120A and the second sliding surface 1120B varies along the length of the track. For instance at a first location 1126, i.e., the location of the unit 1130 in FIG. 7B, on the lower portion 1122 of the track 1120, the distance between the first sliding surface 1120A and the second sliding surface 1120B is D3. The first location 1126 is proximal to the flipping area 1123 with respect to the central crossing plane CCP. At a second location 1127, i.e., the location of the unit 1130 in FIG. 7C, on the lower portion 1122 of the track 1120, the distance between the first sliding surface 1120A and the second sliding surface 1120B is D4. In the illustrated example, the second location 1127 is further from the flipping area 1123, or closer to the central crossing plane CCP, than the first location 1126, and D4 is smaller than D3. As can be seen in FIGS. 7A-7E, from the first location 1126 to the second location 1127 of the track 1120, the distance between the first and second sliding surfaces 1120A and 1120B gradually decreases.

In the illustrated example, the mounting portion 1134 has a support structure 1140 and the first sliding arrangement 1134A is fixedly connected to the support structure 1140. Further, the mounting portion 1134 has a support element 1144 having a first end 1144A connected to the engaging portion 1132 and a second end 1144B connected to the second sliding arrangement 1134B. The support element 1144 is slidably mounted to the support structure 1140. The unit 1130 further includes a biasing member 1148 disposed between the engaging portion 1132 and the first sliding arrangement 1134A such that the biasing member 1148 biases the engaging portion 1132 away from the first sliding arrangement 1134A. Thus, the biasing member 1148 keeps the second sliding arrangement 1134B tightly engaged with the second sliding surface 1120B, and when the unit 1130 moves along the track 1120, the second sliding arrangement 1134B follows the contour/curvature of the second sliding surface 1120B. As the support element 1144 is slidably mounted to the support structure 1140, the second sliding arrangement 1134B sliding on the second sliding surface 1120B causes the engaging portion 1132 to move with respect to the mounting portion 1134, and as a result, with respect to the first sliding arrangement 1134A and the first sliding surface 1120A, or in other words with respect to the track 1120. Thus the distance between the engaging portion 1132 and the track 1120 changes in response to the varying distance between the first sliding surface 1120A and the second sliding surface 1120B.

The first sliding surface 1120A, at the lower portion 1122, has a planner portion 1120A′ intersecting with the central crossing plane CCP, and an inclined portion 1120A″ adjacent each flipping area 1123 and 1124. The first location 1126 of the track 1120 is disposed at the inclined portion 1120A″ and the second location 1127 of the track 1120 is disposed at the planner portion 1120A′. In the illustrated example, the distance between the first and second sliding surfaces 1120A and 1120B remains constant throughout the inclined portion 1120A″.

At a third location 1128, i.e., the location of the unit 1130 in FIG. 7D, on the lower portion 1122 of the track 1120, the distance between the first sliding surface 1120A and the second sliding surface 1120B is D5. In the illustrated example, the third location 1128 is disposed at the planner portion 1120A′ and adjacent said inclined portion 1120A″ of the first sliding surface 1120A. The distance D5 is greater than the distance D4 and smaller than the distance D3. In some examples, the distance D5 can be equal to the distance D3.

At a fourth location 1129, the location of the unit 1130 in FIG. 7E, on the lower portion 1122 of the track 1120, the distance between the first sliding surface 1120A and the second sliding surface 1120B is D6. In the illustrated example, the fourth location 1129 is disposed at the planner portion 1120A′ and is disposed closer to the central crossing plane CCP than the second location 1127. The distance D6 is greater than the distance D4 and smaller than the distance D3. In some examples, the distance D5 can be equal to the distance D3.

During the operation of the caterpillar assembly 1100, i.e., movement of the unit 130 in a clockwise direction along the track, when the unit 1130 crosses the flipping area 1123, and arrives at the first location 1126, the unit 1130 remains closer to the track 1120 by virtue of the large distance D1 between the first sliding surface 1120A and the second sliding surface 1120B, thereby passing over any obstacles that may be present on the advancement surface, The unit 1130 remains closer to the track 1120 until it reaches the second location 1127 where the engaging face 1135 becomes parallel to the advancement surface (not shown). This is important because if the unit 1130 is distant from the track 1120 (as it is at the second location 1127), the engaging face 1135 (or at least a corner thereof) can possibly hit the advancement surface during transition of the unit 1130 from the inclined portion 1020A″ to the planner portion 1120A′. The variation in distance enables the smooth movement of the unit 1130 along the track 1120 during operation of the caterpillar assembly 1100.

Once the unit 1130 reaches the second location 1127, the engaging portion 1132 moves further from the track 1120 by virtue of the distance D2 being smaller than D1, and the engaging face 1135 pounds the advancement surface by virtue of the biasing force of the biasing member. In the illustrated example, the unit 1130 is a gripper unit and grips the advancement surface upon reaching at the second location 1127. Such pounding can contribute to firm engagement with the advancement surface before vacuum is applied. As described above, with respect to the moving system, the track 1120 is then moved with respect to the fixed unit 1130. As the track 1120 moves and the unit 1130 reaches the fourth location, the distance D6 being greater than D4 causes the track to move with respect to the engaging portion 1132 and towards the engaging portion 1132, thereby bringing the track 1120 and thus the whole caterpillar assembly 1100 closer to the advancement surface thereby providing more stability to the caterpillar assembly 1100 with respect to the advancement surface.

Although the caterpillar assembly 1100 has been described above with reference to a single unit 1130, it is to be understood that there are more than one units and the descriptions applies to each one of them. Also, the description refers in detail to one flipping area 1123 and the respective locations of the lower portion 1122 of the track 1120, the description applies analogously to the other flipping area 1124 and its respective first, second, third, and fourth locations.

1-81. (canceled)

82. A caterpillar assembly for moving along a surface, the assembly having a longitudinal reference plane comprising a longitudinal axis and a central reference plane perpendicular to the longitudinal reference plane and comprising the longitudinal axis and a central axis perpendicular to the longitudinal axis, the assembly having at least one surface gripping face, at least a portion of which is parallel to the central reference plane and which is configured, when in operation, to face said surface, the caterpillar assembly comprising:
a moving system; and
a plurality of vacuum grippers each having a gripping face, the vacuum grippers being arranged so that at each moment, gripping faces of at least two vacuum grippers define said surface gripping face of the assembly and are configured for being attached to said surface when vacuum is applied to these grippers, each gripper being mounted to the moving system so as to be moved along the longitudinal reference plane;
each vacuum gripper is provided with an individual vacuum pump configured for selectively creating vacuum within the gripper; and
at least one of the following combinations:
(a) a pump manipulator configured to initiate the operation of the vacuum pump once the vacuum gripper reaches a predetermined starting position, and wherein optionally said caterpillar assembly further comprises at least one starting position indicator configured for signaling to the pump manipulator of each gripper when the gripper reaches the predetermined starting position; or
(b) a vacuum releaser configured to release vacuum in the vacuum gripper once the vacuum gripper reaches a predetermined finishing position, and wherein optionally said caterpillar assembly further comprises at least one finishing position indicator configured for signaling to the vacuum releaser of each gripper when the gripper reaches the predetermined finishing position.

83. The caterpillar assembly of claim 82, wherein each of the vacuum grippers is configured for maintaining the vacuum after termination of operation of the vacuum pump, during the time when the gripping face of the vacuum gripper is attached to the surface, whereby the gripper is configured to have the following operational modes: a suction mode when the vacuum is created by the vacuum pump and a vacuum mode when the vacuum is maintained after the termination of operation of the vacuum pump.

84. The caterpillar assembly of claim 82, wherein said moving system comprises a stationary track and wherein each gripper is configured for slidingly engaging the stationary track.

85. A caterpillar assembly for moving along a surface, the assembly having a longitudinal reference plane comprising a longitudinal axis and a central reference plane perpendicular to the longitudinal reference plane and comprising the longitudinal axis and a central axis perpendicular to the longitudinal axis, the assembly having at least one surface gripping face, at least a portion of which is parallel to the central reference plane and which is configured, when in operation, to face said surface, the caterpillar assembly comprising:
a moving system; and
a plurality of vacuum grippers each having a gripping face, the vacuum grippers being arranged so that at each moment, gripping faces of at least two vacuum grippers define said surface gripping face of the assembly and are configured for being attached to said surface when vacuum is applied to these grippers, each gripper being mounted to the moving system so as to be moved along the longitudinal reference plane, optionally from one side to the other side of the central reference plane;
each vacuum gripper is provided with at least one individual vacuum pump configured for selectively creating vacuum within the gripper.

86. The caterpillar assembly of claim 85, further comprising a vacuum system configured for selectively applying vacuum to the vacuum grippers so that, at each time, vacuum is simultaneously maintained within each of the at least two vacuum grippers whose gripping faces define the surface gripping face.

87. The caterpillar assembly of claim 85, wherein said moving system comprises a movable track, wherein each gripper is configured for being fixedly connected to the movable track and wherein, optionally, the movable track is in the form of an endless movable track constituted by one of the following:
a continuous conveyer flexible strap; or
a succession of discrete elements pivotally connected to each other via pivot axles.

88. The caterpillar assembly of claim 87, wherein said endless movable track is movable by a moving mechanism so as to move each gripper along the longitudinal reference plane.

89. The caterpillar assembly of claim 88, wherein said endless movable track is movable by a moving mechanism so as to bring each gripper from one side to the other side of the central reference plane along the longitudinal reference plane.

90. A vacuum gripper unit for use in a movable assembly having a moving system, for gripping attachment of the assembly to a surface, the vacuum gripper unit comprising:
a gripping portion with a gripping face configured to be attached to the surface when vacuum is applied thereto, and a mounting portion opposite to the gripping portion;
the mounting portion configured for being mounted to the moving system via at least one attachment element; and
an adjusting device connected at one end thereof to the gripping portion of the vacuum gripper and at another end thereof to the mounting portion and configured for adjusting a distance between the gripping portion and the mounting portion, said vacuum gripper further comprising an individual vacuum pump configured for selectively creating vacuum within the gripper.

91. A vacuum gripper unit for use in a movable assembly having a moving system, for gripping attachment of the assembly to a surface, the vacuum gripper unit comprising:
a gripping portion with a gripping face configured to be attached to the surface when vacuum is applied thereto, and a mounting portion opposite to the gripping portion;
the mounting portion configured for being mounted to the moving system via at least one attachment element;
said vacuum gripper unit is provided with at least one individual vacuum pump configured for selectively creating vacuum within the gripper.

92. A vacuum gripper unit for use in a caterpillar assembly, optionally, as defined in any one of claims, the assembly comprising a plurality of vacuum grippers for gripping attachment of the assembly to a surface and a moving system for moving the grippers to successively bring them into contact with said surface, the moving system comprising an endless movable track constituted by a plurality of discrete track elements, each associated with a vacuum gripper unit, and a plurality of pivot axles via which the track elements are pivotally connected to each other, the vacuum gripper unit having a central axis and comprising:
a gripping portion with a gripping face oriented perpendicular to the central axis of the gripper and attachable to said surface when vacuum is applied to the gripping face;
a mounting portion spaced from the gripping face along the central axis of the gripper and comprising an attachment extension oriented transversely to the central axis and having two attachment ends on two sides of the central axis, the attachment ends being each pivotally connectable to a pivot axle, enabling the attachment extension to constitute the discrete track element of the movable track when the caterpillar assembly is assembled;
wherein, optionally, the attachment extension has two attachment extension portions extending in opposite directions from the central axis of the gripper, each having a proximal end adjacent the central axis and a distal end spaced from the central axis and pivotally connectable to a pivot axle,
said vacuum gripper further comprising an individual vacuum pump configured for selectively creating vacuum within the gripper.

93. A movable assembly for attaching to a non-horizontal advancement surface and moving therealong; said movable assembly comprising:
a track having an upward facing sliding surface, a downward facing sliding surface, and at least one sideward facing sliding surface;
a plurality of gripper units by virtue of which said movable assembly is configured to be attached to said advancement surface, each comprising:
a gripping portion having a gripping face configured to be selectively fixable to said advancement surface, and defining a gripping plane when fixed thereto; said movable assembly having a longitudinal axis extending along the track, and a lateral axis extending perpendicularly thereto, each of which being configured to be parallel to said gripping plane; and
a mounting portion configured to be slidingly mounted to said track, so as to enable said movable assembly to move with respect thereto along said advancement surface, said mounting portion comprising:
an upper sliding arrangement configured for slidingly engaging said upward facing surface of said track so as to support said movable assembly when at least one of said axes is oriented in an acute angle with respect to the horizon;
a lower sliding arrangement configured for slidingly engaging said downward facing surface of said track, so as to thereby support said movable assembly when at least one of said axes is oriented in an obtuse angle with respect to the horizon; and
at least one side sliding arrangement configured for slidingly engaging said sideward facing sliding surface, so as to support said movable assembly when said lateral axis is oriented in an angle with respect to the horizon.

94. A caterpillar assembly movable on a non-horizontal advancement surface, said caterpillar assembly comprising:
a track formed with a first sliding surface and a second sliding surface spaced from said first sliding surface to a distance varying along the length of the track;
a plurality of units mounted to said track and successively movable therealong to facilitate advancement of said caterpillar assembly on said advancement surface, each of said units comprising:
a mounting portion comprising a first sliding arrangement in sliding engagement with said first sliding surface, and a second sliding arrangement in sliding engagement with said second sliding surface;
an engaging portion engageable with said advancement surface and operatively connected to said second sliding arrangement, said engaging portion being movable with respect to said mounting portion as its respective unit moves along said track, in response to the variation in said distance between said first and second sliding surfaces.

95. The caterpillar assembly of claim 94, wherein said engaging portion comprises an engaging face defining an engaging plane coinciding with said moving surface during engagement of said engaging portion therewith, and said track comprises a central reference plane, disposed above and parallel to said engaging plane during said engagement, dividing said track to an upper and lower portions, and wherein during said movement of said units along said track, each of which flips between a lower side and an upper side of the central reference plane, at least twice, at two respective flipping areas on the track, the two flipping areas being symmetrically disposed on either side of a central crossing plane defined perpendicularly to said central reference plane.

96. The caterpillar assembly of claim 95, wherein at a first location of the lower portion of the track disposed proximal to one of said flipping areas with respect to said central crossing plane, said second sliding surface is spaced to a first distance from said first sliding surface, and at a second location of the lower portion of the track disposed further from said one of said flipping areas than said first location, said second sliding surface is spaced from said first sliding surface to a second distance being smaller than said first distance.

97. The caterpillar assembly of claim 96, wherein at said lower portion of said track, said first surface comprises a planner portion intersecting with said central crossing plane, and an inclined portion adjacent said one of said flipping areas, and wherein said first location is disposed at said inclined portion, and said second location is disposed at said planner portion.

98. The caterpillar assembly of claim 94, wherein said one of said flipping areas, are either one of said flipping areas.

99. The caterpillar assembly of claim 94, wherein said unit is constituted by said gripper unit of claim 11.

100. A gripper unit for use in a caterpillar assembly of claim 94.

101. A track for use in a caterpillar assembly of claim 94.
